(19) United States
(12) Patent Application Publication
(10) Pub. No.: US 2025/0203675 A1
(43) Pub. Date: Jun. 19, 2025

(54) METHOD TO HANDLE QOS IN WIRELINE WIRELESS CONVERGENCE

(71) Applicant: CABLE TELEVISION LABORATORIES, INC., Louisville, CO (US)

(72) Inventors: Rahil Gandotra, Boulder, CO (US); Yunjung Yi, Vienna, VA (US)

(21) Appl. No.: 19/054,511

(22) Filed: Feb. 14, 2025

Related U.S. Application Data
(63) Continuation-in-part of application No. 18/899,073, filed on Sep. 27, 2024.
(60) Provisional application No. 63/554,850, filed on Feb. 16, 2024.
(60) Provisional application No. 63/554,853, filed on Feb. 16, 2024.
(60) Provisional application No. 63/681,259, filed on Aug. 9, 2024.
(60) Provisional application No. 63/681,275, filed on Aug. 9, 2024.
(60) Provisional application No. 63/620,653, filed on Jan. 12, 2024.
(60) Provisional application No. 63/620,658, filed on Jan. 12, 2024.
(60) Provisional application No. 63/541,331, filed on Sep. 29, 2023.
(60) Provisional application No. 63/541,334, filed on Sep. 29, 2023.

(51) Int. Cl. H04W 76/10; H04L 9/40; H04W 28/02; H04W 28/26

(52) U.S. Cl. CPC H04W 76/10; H04L 63/0485; H04W 28/0268; H04W 28/26

(57) ABSTRACT

Various methods and systems of the present disclosure provide a protocol data unit (PDU) set based quality of service (QoS) handling in a wireline access. To support the PDU Set based QoS handling in the wireline access, one or more PDU Set QoS parameters and/or PDU Set information may be provided to one or more wireline nodes (e.g., a wireline gateway access function (W-AGF) and/or a residential gateway (RG) etc.). When the W-AGF receives one or more N2 requests associated with one or more PDU session resources, the W-AGF maps one or more QoS profiles received from 5G core (5GC) to a wireline access user plane (W-UP) QoS level. The W-AGF sets up one or more W-UP resources based on the W-UP QoS level for a PDU session. Further, various methods and systems of the present disclosure also provide low latency, low loss, and scalable throughput (L4S) enabled wireline access.

### CROSS REFERENCE TO RELATED APPLICATIONS

This application claims the benefit of U.S. provisional application No. 63/554,850 filed Feb. 16, 2024, which also claims the benefit of U.S. provisional 63/554,853 filed Feb. 16, 2024, which is a continuation in part of U.S. nonprovisional application Ser. No. 18/899,073 filed Sep. 27, 2024 which claims the benefit of U.S. provisional application Nos. 63/681,259 filed Aug. 9, 2024, 63/681,275 filed Aug. 9, 2024, 63/620,653 filed Jan. 12, 2024, 63/620,658 filed Jan. 12, 2024, 63/541,331 filed Sep. 29, 2023, and 63/541,334 filed Sep. 29, 2023, which are incorporated by reference as if fully set forth.

### BACKGROUND OF THE INVENTION

Communication networks may include various types of networks, such as but not limited to wireless networks and wireline networks. Many applications executed by various devices in the communication networks may require seamless and high-quality communication across the different types of networks to satisfy one or more quality of service (QoS) requirements. Conventional QoS handling techniques focus on either wireless or wireline networks independently. Therefore, when a data session spans through both the wireless and wireline networks, satisfying the QoS requirements is difficult, thereby causing bottlenecks, service degradation, and inefficient use of network resources. Therefore, there is a need for an improved and efficient QoS handling technique that improves network efficiency, enhances user experience, and provides a scalable architecture in wireline and wireless networks.

### SUMMARY OF THE INVENTION

In an embodiment of the present disclosure, a method performed by a wireline access gateway function (W-AGF) is provided. The method comprises receiving, from a core network (CN) node, at least one quality of service (QoS) profile comprising one or more protocol data unit (PDU) Set QoS parameters. The method comprises mapping the one or more PDU Set QoS parameters to one or more wireline access user plane (W-UP) QoS levels. The method comprises receiving a PDU session resource setup request including at least one PDU Set QoS parameter of the one or more PDU Set QoS parameters indicative of PDU Set QoS handling. The method comprises reserving one or more wireline access resources based on at least one W-UP QoS level of the one or more W-UP QoS levels corresponding to the at least one PDU Set QoS parameter.

In an embodiment of the present disclosure, a device comprising a memory, a transceiver, and a processor is provided. The transceiver is configured to receive, from the CN node, at least one QoS profile comprising one or more PDU Set QoS parameters. The processor is configured to map the one or more PDU Set QoS parameters to one or more W-UP QoS levels. The transceiver is configured to receive a PDU session resource setup request including at least one PDU Set QoS parameter of the one or more PDU Set QoS parameters indicative of PDU Set QoS handling. The processor is configured to reserve one or more wireline access resources based on at least one W-UP QoS level of the one or more W-UP QoS levels corresponding to the at least one PDU Set QoS parameter.

In an embodiment, the device is a W-AGF in communication with a residential gateway (RG) and the CN node.

In an embodiment, the W-AGF establishes a PDU session between the RG and the CN node using the one or more wireline access resources.

In an embodiment, the at least one QoS profile further comprises session management (SM) information comprising at least one of: one or more QoS rules, or a protocol description for identifying the one or more PDU Set QoS parameters.

In an embodiment, the W-AGF transmits a PDU session establishment accept message to the RG.

In an embodiment, the W-AGF transmits a PDU session resource setup response message to the CN node.

In an embodiment, the W-AGF modifies the PDU session based on a handover between a wireline access and a wireless mobile communications access.

In an embodiment, the one or more PDU Set QoS parameters or the at least one QoS profile includes one or more of: a PDU Set delay budget (PSDB), a PDU Set error rate (PSER), or a PDU Set integrated handling information (PSIHI).

In an embodiment, the PSDB includes a wireline delay budget and a CN delay budget.

In an embodiment of the present disclosure, a method performed by the W-AGF is provided. The method includes receiving, from a CN node, one or more QoS profiles. The method includes mapping the one or more QoS profiles to one or more W-UP QoS levels. The method includes receiving a PDU session resource setup request including an indication associated with low latency, low loss, and scalable throughput (L4S). The method includes, on a condition that one or more PDUs of a PDU session comprise an L4S indication, reserving one or more L4S enabled wireline access resources based on at least one W-UP QoS level of the one or more W-UP QoS levels associated with the L4S indication.

In an embodiment of the present disclosure, a device comprising a memory, a transceiver, and a processor is provided. The transceiver is configured to receive, from a CN node, one or more QoS profiles. The processor is configured to map the one or more QoS profiles to one or more W-UP QoS levels. The transceiver is configured to receive a PDU session resource setup request including an indication associated with L4S. The processor is configured to, on a condition that one or more PDUs of a PDU session comprise an L4S indication, reserve one or more L4S enabled wireline access resources based on at least one W-UP QoS level of the one or more W-UP QoS levels associated with the L4S indication.

In an embodiment, the device is an W-AGF in communication with the CN node and a RG.

In an embodiment, the W-AGF establishes an L4S enabled PDU session between the RG and the CN node using the one or more L4S enabled wireline access resources.

In an embodiment, the L4S indication is a QoS flow identifier (QFI) in a general packet radio service (GPRS) tunneling protocol user plane (GTP-U) header in the one or more PDUs.

In an embodiment, the W-AGF marks an explicit congestion notification (ECN) indicator in the one or more PDUs upon detecting congestion.

In an embodiment, the W-AGF transmits, to the RG, a PDU session establishment accept message comprising the ECN indicator.

In an embodiment, the W-AGF transmits a PDU session resource setup response message to the CN node.

In an embodiment of the present disclosure, a method performed by a gateway function is provided. The method comprises receiving, from a session management function (SMF), protocol data unit (PDU) session management (SM) information indicative of activating PDU Set quality of service (QoS) handling. The method comprises reserving one or more non-3GPP access resources based on the PDU SM information. The method comprises establishing a PDU session with a user equipment (UE) using the one or more non-3GPP access resources. The method comprises establishing a dedicated internet protocol security (IPsec) Child security association (SA) with the UE for at least one QoS flow associated with the PDU session.

In an embodiment, the method further comprises exchanging one or more PDUs associated with the at least one QoS flow with the UE using the dedicated IPsec Child SA.

In an embodiment, the PDU SM information comprises a protocol description.

In an embodiment, the method further comprises identifying, based on the protocol description, a PDU Set associated with the PDU session for which PDU Set QoS handling is activated.

In an embodiment, the PDU SM information comprises one or more QoS parameters.

In an embodiment, the method further comprises determining, based on the one or more QoS parameters, one or more differentiated service code point (DSCP) values associated with the dedicated Child SA.

In an embodiment, establishing the dedicated IPsec Child SA comprises transmitting, to the UE, a request to create the dedicated Child SA, wherein the request to create the dedicated Child SA comprises the one or more DSCP values.

In an embodiment, the gateway function is a non-3GPP interworking function (N3IWF) in communication with an untrusted non-3GPP access network.

In an embodiment, the gateway function is a trusted non-3GPP gateway function (TNGF) in communication with a trusted non-3GPP access network.

In an embodiment of the present disclosure a device comprising a memory, a transceiver, and a processor. The transceiver and the processor are configured to receive, from a SMF, PDU SM information indicative of activating PDU Set QoS handling. The transceiver and the processor are configured to reserve one or more non-3GPP access resources based on the PDU SM information. The transceiver and the processor are configured to establish a PDU session with a UE using the one or more non-3GPP access resources. The transceiver and the processor are configured to establish a dedicated IPsec Child SA with the UE for at least one QoS flow associated with the PDU session.

In an embodiment of the present disclosure, a method performed by a gateway function is provided. The method comprises receiving, from a SMF, PDU SM information indicative of explicit congestion notification (ECN) marking. The method comprises reserving one or more non-3GPP access resources based on the PDU SM information. The method includes establishing a PDU session with a UE using the one or more non-3GPP access resources. The method includes establishing a dedicated IPsec Child SA with the UE for at least one low latency, low loss, and scalable throughput (L4S) flow associated with the PDU session.

In an embodiment, the method further comprises exchanging one or more PDUs associated with the at least one QoS flow with the UE using the dedicated IPsec Child SA.

In an embodiment, the PDU SM information comprises a protocol description.

In an embodiment, the method further comprising identifying, based on the protocol description, a PDU Set associated with the PDU session for which ECN marking is activated.

In an embodiment, the PDU SM information comprises one or more QoS parameters.

In an embodiment, the method further comprises determining, based on the one or more QoS parameters, one or more differentiated service code point (DSCP) values associated with the dedicated Child SA.

In an embodiment, establishing the dedicated IPsec Child SA comprises transmitting, to the UE, a request to create the dedicated Child SA, wherein the request to create the dedicated Child SA comprises the one or more DSCP values.

In an embodiment, the gateway function is an N3IWF in communication with an untrusted non-3GPP access network.

In an embodiment, the gateway function is a TNGF in communication with a trusted non-3GPP access network.

In an embodiment of the present disclosure, a device comprising a memory, a transceiver, and a processor is provided. The transceiver and the processor are configured to receive, from a SMF, PDU SM information indicative of ECN marking. The transceiver and the processor are configured to reserve one or more non-3GPP access resources based on the PDU SM information. The transceiver and the processor are configured to establish a PDU session with a UE using the one or more non-3GPP access resources. The transceiver and the processor are configured to establish a dedicated IPsec Child SA with the UE for at least one L4S flow associated with the PDU session.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1 is an illustration of an example device;

FIG. 2 illustrates an example communication system;

FIG. 3 illustrates an example of a functional split between a next generation radio access network (NG-RAN) and 5G core (5GC);

FIG. 4 illustrates an example of a protocol stack for a user plane and a control plane;

FIG. 5A illustrates a procedure for an example solution for a wireline access gateway function (W-AGF) and a residential gateway (RG), according to one or more embodiments;

FIG. 5B illustrates a procedure for an example solution for a W-AGF and a RG (e.g., 5G-RG), according to one or more embodiments;

FIG. 6A illustrates a procedure for an example solution for a W-AGF and a RG, according to one or more embodiments;

FIG. 6B illustrates a procedure for an example solution for a W-AGF and a RG (e.g., FN-RG), according to one or more embodiments;

FIG. 7 illustrates an example architecture for low latency, low loss, and scalable throughput (L4S) support in a wireline access, according to one or more embodiments;

FIG. 8A illustrates an example procedure for an L4S support in a wireline access, according to one or more embodiments;

FIG. 8B illustrates an example procedure for an L4S support in a wireline access, according to one or more embodiments;

FIG. 9A illustrates a procedure for an example solution for a W-AGF and a RG, according to one or more embodiments;

FIG. 9B illustrates a procedure for an example solution for a W-AGF and a RG (e.g., FN-RG), according to one or more embodiments;

FIG. 10 illustrates a procedure for an example untrusted non-3GPP access, according to one or more embodiments;

FIG. 11 illustrates a procedure for an example trusted non-3GPP access, according to one or more embodiments;

FIG. 12 illustrates a procedure for an example untrusted non-3GPP access, according to one or more embodiments;

FIG. 13 illustrates a procedure for an example trusted non-3GPP access, according to one or more embodiments;

FIG. 14 illustrates a flowchart of an example process implemented by a W-AGF for a protocol data unit (PDU) set quality of service (QoS) handling enabled wireline access, according to one or more embodiments;

FIG. 15 illustrates a flowchart of an example process implemented by a W-AGF for an L4S enabled wireline access, according to one or more embodiments;

FIG. 16 illustrates a flowchart of an example process implemented by a gateway function for a PDU set QoS handling enabled wireline access, according to one or more embodiments; and

FIG. 17 illustrates a flowchart of an example process implemented by a gateway for an L4S enabled wireline access, according to one or more embodiments.

### DETAILED DESCRIPTION OF THE PREFERRED EMBODIMENTS

The underlying principle of a communication system is to enable one or more devices to communicate with one or more other devices. At a basic level, each device may need some basic components to operate. Any device referenced herein, including the hardware (e.g., virtual or physical) to run a function, software entity, application, or the like, may be understood to have at least one or more of the following components (e.g., where there may be one or more of each component): a processor, a transceiver (e.g., which may or may not be integrated with the processor), an input (e.g., microphone, keyboard, mouse, etc.), an output (e.g., port for outputting display signals, a display, a touch screen, a printer, etc.), a power source, a positioning chip (e.g., GPS, GLONASS, etc., which may or may not be integrated with the processor and/or transceiver), button (e.g., for controlling the specific function of one or more aspects of the device). These components may be operably connected to one another, meaning that there may be a direct connection or an indirect connection to one or more of the components.

A UE may be interchangeable with a station (STA), a mobile station, a fixed or mobile subscriber unit, a subscription-based unit, a pager, a cellular telephone, a personal digital assistant (PDA), a smartphone, a laptop, a netbook, a computer, a server, a functional entity (e.g., virtual and/or physical) a wireless sensor, a hotspot or Mi-Fi device, an Internet of Things (IoT) device, a watch or other wearable, a head-mounted display (HMD), a vehicle, a drone, or the like.

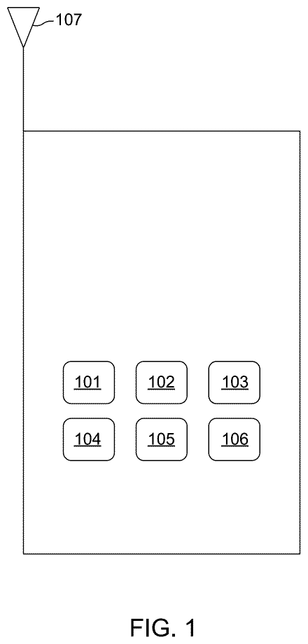

FIG. 1 is an illustration of an example device. In one case, the device may be a User Equipment (UE) suited for mobile operation. In this example, the UE may have a processor 101, a transceiver 102, a touchscreen 103, a power source 104 (e.g., a battery), a GPS 105, one or more other components 106 (e.g., as described herein), and/or an antenna 107.

Generally, a processor may be any kind of processor, such as a processor capable of carrying out one or more of the techniques described herein. A transceiver may be configured to transmit and receive signals. In one case, there may be a separate receiver and transmitter. A transceiver may be connected to one or more antennas (e.g., MIMO technology). A transceiver may be configured to transmit RF signals. In one case, a transceiver may be configured to transmit light signals (e.g., IR, UV, laser, etc.). A transceiver may be configured to send/receive more than one type of RF signal (e.g., different radio access technologies for one transceiver, or multiple transceivers each dedicated to a specific radio access technology). A transceiver may be configured to modulate signals for transmission, and demodulate signals for reception. The UE may be capable of full duplex operation, where there is transmission and reception of some or all signals may be concurrent and/or simultaneous (e.g., different timing/spacing for UL or DL).

Different radio access technologies may be used with one or more transceivers (e.g., 802.11, WCDMA, CDMA2000, GSM, LTE, LTE-A, LTE-A Pro, NR etc.).

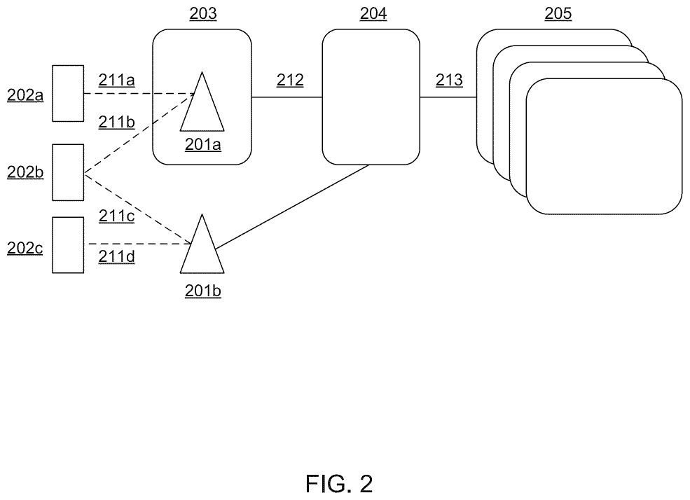

FIG. 2 illustrates an example communication system. This example may be used to illustrate multiple wireless protocols. For all wireless protocols, there may be mobile or stationary devices (e.g., 202a, 202b, 202c, such as a UE) that connect to a base station device 201a and/or 201b. In one case, this may enable a mobile device to connect to a service (e.g., a remote server) or data network (e.g., internet).

In one case, the base stations (201a, 201b) may be equivalent to, and/or interchangeable with, a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, transmission receive point (TRP), network (NW), RP (reception point), RRH (radio remote head), DA (distributed antenna), BS (base station), a sector (of a BS), and a cell (e.g., a geographical cell area served by a BS). Each base station may be representative of more than one base station (e.g., multiple transmission reception points).

Generally, a communication system may use a combination of wired and wireless connections at different points in the system. One or more wireless technologies may (e.g., channel access methods), may include code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

A base station may be configured to transmit and/or receive wireless signals on one or more carrier frequencies, which may be referred to as a cell (not shown). A base station (201a, 201b) may communicate with one or more UEs (202a, 202b, 202c) over an air interface (211a, 211b, 211c, 211d).

In one case, one or more base stations may implement LTE radio access and NR radio access together, for instance using dual connectivity (DC) approach. Therefore, the system (e.g., and perhaps one or more UEs) may implement multiple types of radio access technologies that uses more than one type of base station (e.g., an eNB and a gNB).

In one case, the communication system may include a radio access network (RAN) 203, a core network 206, and one or more other elements represented by 205 (e.g., public switched telephone network (PSTN), the Internet, and other networks or the like).

In one scenario using FIG. 2 as an illustration, a RAN 203 may be in communication with a CN 204. The base station 201a may be an eNB, and the access technology may be based on E-UTRA (e.g., LTE, etc.). The communication system may handle data transmission from the UE 202a. The data may have varying quality of service (QoS) requirements, such as differing throughput requirements, latency requirements, error tolerance requirements, reliability requirements, data throughput requirements, mobility requirements, and the like. The CN 204 may provide call control, billing services, mobile location-based services, pre-paid calling, Internet connectivity, video distribution, etc., and/or perform high-level security functions, such as user authentication. Although not shown, the RAN 203 and/or the CN 204 may be in direct or indirect communication with other RANs that employ the same RAT as the RAN 203 or a different RAT. For example, in addition to being connected to the RAN 203, which may be utilizing a NR radio access technology, the CN 204 may also be in communication with another RAN (not shown) employing another radio access technology (e.g., E-UTRA, WiFi, etc.). Each of the eNBs may be associated with a particular cell (not shown) and may be configured to handle radio resource management decisions, handover decisions, scheduling of users in the UL and/or DL, and the like. Each eNB may communicate with one another over an X2 interface (not shown).

In one scenario using FIG. 2 as an illustration, the RAN 203 and the CN 204 may employ NR radio access technologies and related protocols. The base station may be a gNB 201. The gNB(s) may implement carrier aggregation technology, where multiple component carriers may be transmitted to the UE 202a. A subset of these component carriers may be on unlicensed spectrum while the remaining component carriers may be on licensed spectrum. The UE(s) may communicate with the gNB(s) using transmissions associated with a scalable numerology (e.g., subcarrier spacing, etc.). For example, the OFDM symbol spacing and/or OFDM subcarrier spacing may vary for different transmissions, different cells, and/or different portions of the wireless transmission spectrum. The UE(s) may communicate with gNB(s) using subframe or transmission time intervals (TTIs) of various or scalable lengths (e.g., containing a varying number of OFDM symbols and/or lasting varying lengths of absolute time). The gNB(s) may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF), routing of control plane information towards Access and Mobility Management Function (AMF), and the like. The gNB(s) may communicate with one another over an Xn interface.

Not shown (e.g., but still possibly part of one or more example scenarios described herein), the CN may include one or more AMF, one or more UPF, one or more Session Management Function (SMF), and/or one or more Data Networks (DNs). In one case, the aforementioned elements may be owned and/or operated by an entity other than the CN operator.

In one scenario using FIG. 2 as an illustration, an Internet 205 may include a global system of interconnected computer networks and devices that use common communication protocols, such as the transmission control protocol (TCP), user datagram protocol (UDP) and/or the internet protocol (IP) in the TCP/IP internet protocol suite.

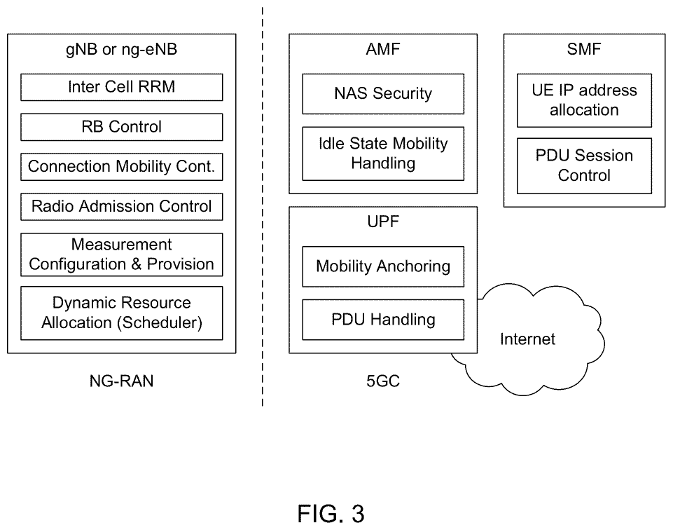

FIG. 3 illustrates an example of a functional split between the NG-RAN and 5GC. The AMF may be connected to one or more gNB the RAN via an N2 interface and may serve as a control node. For example, the AMF may be responsible for authenticating a UE's support for network slicing (e.g., handling of different protocol data unit (PDU) sessions with different requirements), selecting a particular SMF, management of the registration area, termination of non-access stratum (NAS) signaling, mobility management, and the like. Network slicing may be used by the AMF in order to customize CN support for one or more UEs based on the types of services being utilized by the respective UE. For example, different network slices may be established for different use cases such as services relying on ultra-reliable low latency (URLLC) access, services relying on enhanced massive mobile broadband (eMBB) access, services for MTC access, and the like. The AMF may provide a control plane function for switching between the RAN and other RANs that employ other radio technologies (e.g., as described herein). The SMF may be connected to an AMF in the CN via an N11 interface. The SMF may also be connected to a UPF in the CN via an N4 interface. The SMF may select and control the UPF and configure the routing of traffic through the UPF. The SMF may perform other functions, such as managing and allocating UE IP address, managing PDU sessions, controlling policy enforcement and QoS, providing DL data notifications, and the like. A PDU session type may be IP-based, non-IP based, Ethernet-based, and the like. The UPF may be connected to one or more gNB in the RAN via an N3 interface, which may provide a UE with access to packet-switched networks, such as the Internet, to facilitate communications between one or more UEs and IP-enabled devices. The UPF may perform other functions, such as routing and forwarding packets, enforcing user plane policies, supporting multi-homed PDU sessions, handling user plane QoS, buffering DL packets, providing mobility anchoring, and the like. The CN may facilitate communications with other networks. For example, the CN may provide a UE with access to the other networks 212, which may include other wired and/or wireless networks that are owned and/or operated by other service providers. In one example, the UEs may be connected to a local DN through a UPF via an N3 interface to the UPF and an N6 interface between the UPF and the DN. As discussed herein, a NR RAN may be called an NG-RAN and a NR CN may be called a 5GC.

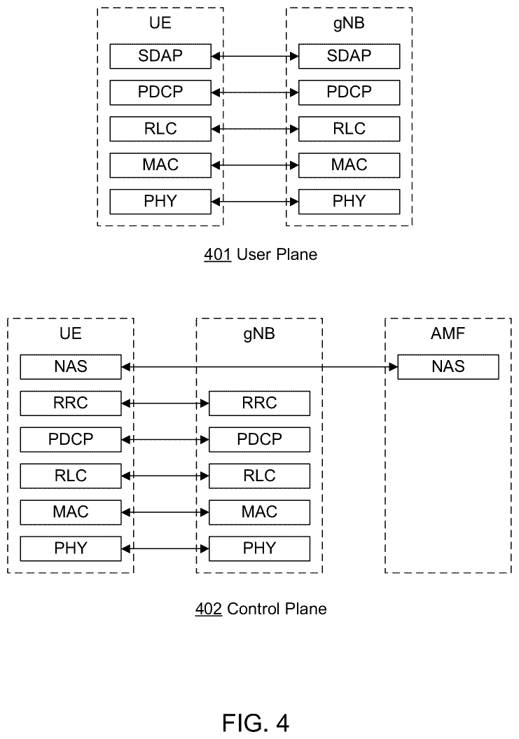

FIG. 4 illustrates an example of a protocol stack for the user plane and control plane. The user plane protocol stack 401 and the control plane stack 402. A higher layer may refer to one or more layers in a protocol stack, or a specific sublayer within the protocol stack. The protocol stack may comprise of one or more layers in a UE or a network node (e.g., eNB, gNB, other functional entity, etc.), where each layer may have one or more sublayers. Each layer/sublayer may be responsible for one or more functions. Each layer/sublayer may communicate with one or more of the other layers/sublayers, directly or indirectly. In some cases, these layers may be numbered, such as Layer 1, Layer 2, and Layer 3. For example, Layer 3 may comprise of one or more of the following: Non Access Stratum (NAS), Internet Protocol (IP), and/or Radio Resource Control (RRC). For example, Layer 2 may comprise of one or more of the following: Packet Data Convergence Control (PDCP), Radio Link Control (RLC), and/or Medium Access Control (MAC). For example, Layer 3 may comprise of physical (PHY) layer type operations. The greater the number of the layer, the higher it is relative to other layers (e.g., Layer 3 is higher than Layer 1). In some cases, the aforementioned examples may be called layers/sublayers themselves irrespective of layer number, and may be referred to as a higher layer as described herein. For example, from highest to lowest, a higher layer may refer to one or more of the following layers/sublayers: a NAS layer, a RRC layer, a PDCP layer, a RLC layer, a MAC layer, and/or a PHY layer. Any reference herein to a higher layer in conjunction with a process, device, or system will refer to a layer that is higher than the layer of the process, device, or system. In some cases, reference to a higher layer herein may refer to a function or operation performed by one or more layers described herein. In some cases, reference to a high layer herein may refer to information that is sent or received by one or more layers described herein. In some cases, reference to a higher layer herein may refer to a configuration that is sent and/or received by one or more layers described herein.

In various examples, a method to support a protocol data unit (PDU) set based quality of service (QoS) handling in a wireline wireless convergence is provided. In that, there is an enhanced extended reality and media service (XRM) architecture. The enhanced XRM architecture provides support for one or more extended reality (XR) services and/or applications based on a non-3GPP access. The enhanced XRM architecture provides one or more PDU Set QoS control mechanisms that may be extended to various non-3GPP access networks. The enhanced XRM architecture provides support for a PDU Set QoS in untrusted and/or trusted accesses (e.g., a non-3GPP interworking function (N3IWF) and/or a trusted non-3GPP Gateway Function (TNGF) etc.). The enhanced XRM architecture provides support for the PDU Set QoS in a wireline access (e.g., a wireline access gateway function (W-AGF) etc.).

In an example, there is a method for a PDU Set based QoS handling in the wireline access. To support the PDU Set based QoS handling in the wireline access, one or more PDU Set QoS parameters and/or PDU Set information may be provided to one or more wireline nodes (e.g., the W-AGF and/or a residential gateway (RG) etc.). In an example, one or more of currently specified PDU Set QoS parameters and/or currently specified PDU Set information may be supported in the wireline access.

In an example, the RG may be a fifth generation RG (5G-RG) and/or a fixed network RG (FN-RG). In an example, the 5G-RG may provide connectivity between one or more networked devices on premises (e.g., home and/or office premises etc.) and the DN (e.g., the internet etc.). The 5G-RG may support both one or more wireless interfaces (e.g., Uu) and one or more wired, i.e., wireline interfaces, toward the 5G core via the W-AGF. In an example, the FN-RG may be a wireline device to connect the one or more networked devices to a wide-area network (WAN).

In an example, the PDU Set based handling is supported for the UEs registered in 3GPP access for a single access PDU session with IP PDU session type, the UEs registered in untrusted and/or trusted non-3GPP accesses for single access PDU session with IP PDU session type, and the RG (e.g., 5G-RG) registered in W-5GAN for single access PDU session with IP PDU session type.

In an example, a PDU Set based handling may include PDU Set identification and marking. A fifth generation wireless system (5G) supports the PDU Set based QoS handling in a next generation radio access network (NG-RAN) with a PDU session anchor (PSA) user plane function (UPF) identifying one or more PDUs (also simply referred to as “PDUs”) that belong to one or more PDU Sets (also simply referred to as “PDU Sets”) based on a protocol description for the PDU Set identification and providing the PDU Set information to the RAN in a general packet radio service (GPRS) tunneling protocol user plane (GTP-U) header. 5GS support for the PDU Set based handling is limited to a NG-RAN access. However, the interaction between one or more applications and the 5GS via the non-3GPP accesses is necessary to enhance efficiency and promote user experience. In an example, a user may be serviced by the 5GC via the trusted and/or untrusted non-3GPP accesses. The user may be serviced by the 5GC via the wireline access such as but not limited to a device behind the RG.

In an example, there may be one or more mechanisms to support the PDU Set based handling over the non-3GPP accesses. In that, an example mechanism provides one or more PDU Set QoS parameters to the non-3GPP access gateways (e.g., the N3IWF and/or the TNGF etc.) to support the PDU Set based QoS handling in the untrusted and/or trusted accesses. In an example, an example mechanism provides the PDU Set information to the non-3GPP access gateways (e.g., the N3IWF and/or the TNGF etc.) to support the PDU Set based QoS handling in the untrusted and/or trusted accesses. In an example, the one or more PDU Set QoS parameters are provided to the one or more wireline access gateway nodes (e.g., the W-AGF and/or the RG etc.) to support the PDU Set based QoS handling in the wireline access. In an example, the PDU Set information is provided to the wireline access gateway nodes (e.g., the W-AGF and/or the RG etc.) to support the PDU Set based QoS handling in the wireline access.

In an example, the N3IWF may bind a QoS flow associated with the one or more PDU Set QoS parameters to an IPsec security association and no other QoS flow may be bound to this IPsec security association. For the QoS flows that are configured for the PDU Set QoS handling, the N3IWF may, based on one or more operator local configurations, use a PDU Set importance received in the GTP-U header to determine a differentiated services code point (DSCP) value marking of the one or more PDUs. In an example, the PDU Set importance based DSCP values may be used to vary a drop precedence between the one or more PDUs. This may avoid causing packet reordering when different DSCP values may be used for a single QoS flow. In an example, enforcement consistency of the DSCP marking may be controlled by the operator.

In an example, a method for supporting the PDU Set based QoS handling with an access traffic steering, switching, and/or splitting (ATSSS) feature is provided.

In an example, to support the PDU Set based QoS handling in the wireline access, the one or more PDU Set QoS parameters (also simply referred to as “PDU Set QoS parameters”) and/or the PDU Set information may be provided to the one or more wireline nodes (e.g., the W-AGF and/or the RG etc.). In that, the one or more PDU Set QoS parameters specified for the NG-RAN may be supported in the wireline access. A PDU Set related assistance information (e.g., a protocol description) specified for the NG-RAN may be supported in the wireline access. The PDU Set information specified for the NG-RAN may be supported in the wireline access.

For supporting the PDU Set based QoS handling in the W-5GAN, the PDU Set based QoS handling by the W-5GAN is determined by the one or more PDU Set QoS parameters in a QoS profile of a QoS flow and/or the PDU Set information provided by the PSA UPF. For the QoS flow with the PDU Set based QoS handling enabled, the one or more PDU Set QoS parameters may be determined by the PCF (e.g., based on information provided by the AF and/or a local configuration etc.) and provided by a session management function (SMF) to the W-AGF as a part of the QoS profile. In another example, the SMF may be configured to support the PDU Set based QoS handling without receiving one or more policy and charging control (PCC) rules from the PCF.

In operation, when the W-AGF receives one or more N2 requests associated with one or more PDU session resources, the W-AGF maps one or more QoS profiles received from the 5GC to a W-UP QoS level. Examples of the PDU Set QoS parameters used to support the PDU Set based QoS handling in the W-5GAN include but are not limited to PDU Set delay budget (PSDB), PDU Set error rate (PSER), and/or PDU Set integrated handling information (PSIHI) etc. At least one PDU Set QoS parameter may be transmitted to the W-5GAN to enable the PDU Set based QoS handling.

The PSDB describes an upper bound for a delay that the PDU Set may experience for the transfer between the RG and an N6 termination point at the UPF, such as a duration between a reception time of a first PDU (e.g., at the N6 termination point for downlink (DL) and/or the RG for uplink (UL) etc.) and a time when all PDUs of the PDU Set are successfully received (e.g., at the RG for the DL and/or the N6 termination point for the UL etc.). The PSDB applies to a DL PDU Set received by the PSA UPF over the N6 interface, and to a UL PDU Set transmitted by the RG.

If the RG (e.g., 5G-RG) supports providing a non-3GPP delay budget for a specific QoS flow, the RG may provide the non-3GPP delay budget to the SMF by using the RG requested PDU session modification procedure. The SMF may compensate for the non-3GPP delay by adjusting a dynamic core network packet delay budget (CN PDB) for the 3GPP network by the non-3GPP delay.

The PSER describes an upper bound for an error rate of the PDU Sets that have been processed by a sender of a link layer protocol (e.g., the W-UP and/or the L-W-UP of the W-5GAN etc.) but that are not successfully delivered by corresponding receiver to an upper layer.

The PSIHI indicates whether all the PDUs of the PDU Set are needed for usage of the PDU Set by an application layer at the receiver.

The SMF may additionally signal non-3GPP QoS assistance information (N3QAI) for each QoS flow to the RG (e.g., 5G-RG). Based on the N3QAI and/or the QoS rule information, the RG may reserve the one or more resources in the non-3GPP network behind the RG. The N3QAI may include the PDU Set QoS parameters.

For the downlink direction, the PSA UPF identifies the PDUs that belong to the PDU Sets and determines the PDU Set information which is transmitted to the W-AGF in the GTP-U header. The PDU Set information comprises but is not limited to one or more of: a PDU Set sequence number, an indication of an end PDU of the PDU Set, a PDU sequence number within the PDU Set, a PDU Set size in bytes, and/or a PDU Set importance etc.

For the uplink direction, the RG (e.g., 5G-RG) identifies the PDU Sets based on the protocol description sent by the SMF with the QoS rule.

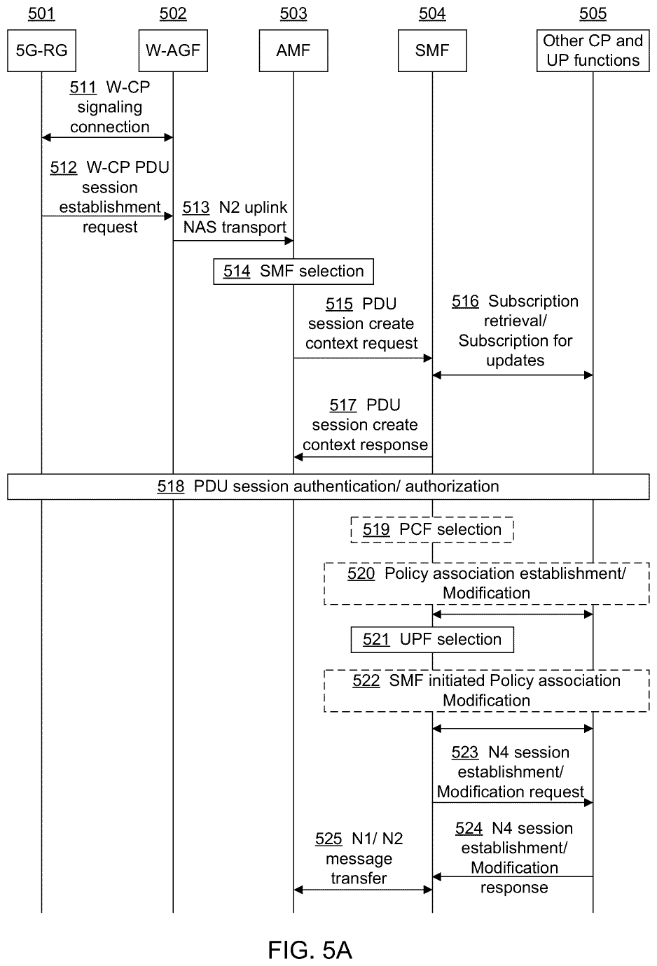

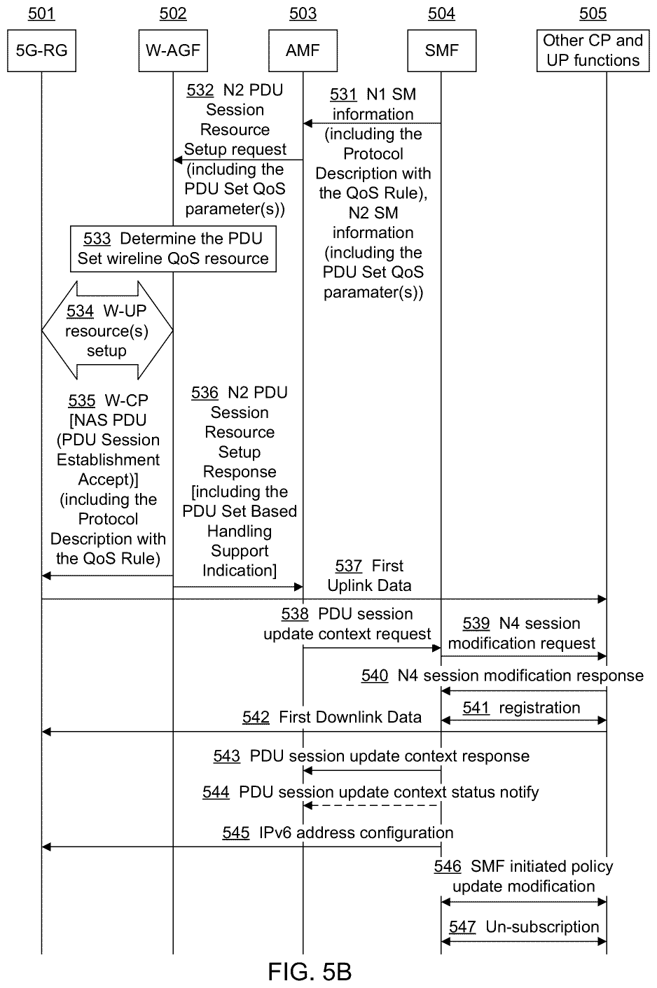

FIGS. 5A-5B illustrate a procedure for an example solution for the W-AGF and the RG (e.g., 5G-RG), according to one or more embodiments. The procedure may be performed between a RG 501, a W-AGF 502, an AMF 503, an SMF 504, and one or more other CP and/or UP functions 505. At 511, one or more processes associated with 5G-RG PDU session establishment may be executed. In an example, the RG 501 may be a 5G-RG.

At 511, the RG 501 (e.g., 5G-RG) and the W-AGF 502 establish a W-CP signaling connection.

At 512-513, the RG 501 (e.g., 5G-RG) transmits a PDU session establishment request message to the AMF 503 via the W-AGF 502. At 512, the PDU session establishment request message may be transmitted to the W-AGF 502 via the W-CP signaling connection. At 513, the W-AGF 502 may transparently forward the PDU session establishment request message in a N2 uplink NAS transport message (e.g., NAS message, user location information, W-AGF identities etc.) to the AMF 503 in the 5GC.

At 514, the AMF 503 selects an SMF, e.g., the SMF 504. In that, the AMF 503 may determine and/or assign appropriate network slices (e.g., single network slice selection assistance information (S-NSSAI) etc.) and data network name (DNN) based on a 5G-RG subscription and one or more operator policies. The AMF 503 may select and/or replace the DNN, and/or may choose an appropriate SMF. The AMF 503 may also handle situations such as but not limited to handovers, error cases, and/or emergency session requests etc.

At 515, the AMF 503 may communicate with the SMF 504 via one or more of the requests: Nsmf_PDUSession_CreateSMContext for one or more new PDU sessions and/or Nsmf_PDUSession_UpdateSMContext for one or more existing PDU sessions. The one or more requests may include information such as but not limited to a subscription permanent identifier (SUPI), the DNN, the S-NSSAI, user location, access type, RAT type, and/or other parameters etc.

At 516, if the SMF 504 lacks session management subscription data for the given SUPI, the DNN, and/or the S-NSSAI etc., the SMF 504 may retrieve the session management subscription data from a unified data management (UDM) via a Nudm_SDM_Get and may subscribe for updates through a Nudm_SDM_Subscribe. The UDM may source the session management subscription data from a unified data repository (UDR) and may include session information such as but not limited to one or more allowed PDU types, one or more SSC modes, and/or one or more internet protocol (IP) configurations etc. For non-roaming and/or specific use cases, the SMF 504 may apply one or more local policies. The SMF 504 may verify the request against the subscription data and determine if redundancy and/or other special handling may be needed. If the request is invalid, the SMF 504 may reject the request and may signal a NAS SM with appropriate cause and possibly release the corresponding PDU session ID. If accepted, the SMF 504 may create and/or update the SM context and respond with a context ID to the AMF 503. Additionally, the SMF 504 may check if one or more security policies, such as integrity protection, need to be enforced based on one or more characteristics of the request.

At 517, from the SMF 504 to the AMF 503, the response may be either a Nsmf_PDUSession_CreateSMContext response (indicating the cause, the SM context ID, and/or the PDU session rejection etc.) and/or an Nsmf_PDUSession_UpdateSMContext response, based on the request received. If the SMF 504 processes the PDU session establishment request, the SMF 504 may create the SM context and transmit the SM context ID to the AMF 503. The SMF 504 may evaluate the UP security policy, and if the integrity protection indicates a requirement, the SMF 504 may reject the PDU session request based on a 5G-RG integrity protection maximum data rate. If the request is rejected, the SMF 504 may inform the AMF 503 with the rejection cause and consider the PDU session ID released, halting the PDU session establishment procedure.

At 518, the secondary authentication and/or authorization may not be performed by the SMF 504 if the request indicates the existing PDU session and/or involves an emergency request and/or an existing emergency PDU session. However, if required during the establishment of the PDU session, the SMF 504 may trigger the secondary authentication and/or authorization via a data network authentication, authorization, and accounting (DN-AAA) server.

At 519, if a dynamic policy and charging control (PCC) is used for the PDU session, the SMF 504 may select a PCF. For the existing PDU session and/or existing emergency PDU session requests, the SMF 504 may use a previously selected PCF for the PDU session. In other cases, the SMF 504 may follow the one or more local policies for the PCF selection.

At 520, the SMF 504 may initiate an SM policy association establishment procedure with the PCF to obtain one or more default PCC rules for the PDU session, including 3GPP data off status, a generic public subscription identifier (GPSI), provisioning server (PVS) fully qualified domain name and IP addresses (FQDN/IP addresses), and/or the S-NSSAI or an alternative S-NSSAI if available. For the existing PDU sessions, the SMF 504 may use one or more policy control request trigger conditions that have been met.

At 521, when the request type indicates the initial request, the SMF 504 may select a session and service continuity (SSC) mode and one or more necessary user plane functions (UPFs) for the PDU session and allocate IP addresses and/or interface identifiers for IPV4, IPV6, and/or unstructured PDU sessions, as per the type. For the existing PDU sessions, the SMF 504 may maintain the same IP address, a PDU session anchor, and/or a SSC mode. In the case of the emergency requests, the SMF 504 may select the UPF and SSC mode 1.

At 522, the SMF 504 may initiate a policy association modification procedure to notify the PCF when specific policy control triggers are met, such as allocating the IP address to the RG 501 (e.g., 5G-RG) during the initial request for dynamic PCC deployment in IPV4, IPV6, or IPv4v6 PDU sessions. If the IP address has already been allocated, the notification may be skipped. Additionally, if the PCF has subscribed to the triggers, such as the RG reporting connection capabilities through URSP rules, the SMF 504 may report the capabilities and the PCF may update policies or generate one or more service data flow (SDF) templates in response. The mapping between one or more connection capabilities and the one or more SDF templates may be implementation-specific.

At 523, when the request type indicates the initial request, the SMF 504 may initiate an N4 session establishment procedure with the one or more selected UPFs and/or may initiate an N4 session modification. During this, the SMF 504 may transmit an N4 session establishment and/or modification request to the UPF, providing packet detection, enforcement, and/or reporting rules for the PDU session. The SMF 504 may request the IP address allocation, provide an inactivity timer, configure trace requirements, and/or manage small data rate control and serving public land mobile network (PLMN) rate control parameters. For specific PDU sessions (e.g., Ethernet and/or IP), the SMF 504 may request a port number, and if redundant transmission is required, the SMF 504 may manage tunnel information for duplication elimination. The SMF 504 may also perform functions such as interworking with time sensitive networking (TSN), enabling explicit congestion notification (ECN) marking for L4S, and including the DNN and the S-NSSAI for specific services.

At 524, the UPF may respond to the N4 session establishment and/or modification request by transmitting an acknowledgment, which may include the allocated IP address and/or prefix if requested. If packet duplication and elimination were indicated, the UPF may provide two CN tunnel information, and if redundant transmission is required, the UPF may allocate the CN tunnel information for two intermediate UPFs (I-UPFs) and a PDU session anchor (PSA) UPF. The response may also include the port number and user-plane node ID for specific PDU sessions, supporting integration with the TSN and/or DetNet networks. The SMF 504 may initiate this procedure with multiple UPFs if needed, and if interworking with the TSN is supported, the UPF may transmit a TL-Container in the response. The SMF 504 may also notify the PCF of an IP address change if subscribed.

At 525, the SMF 504 may transmit a Namf_Communication_N1N2MessageTransfer to the AMF 503, which includes key information for the PDU session establishment. The message may include the PDU session ID and N2 SM information.

In FIG. 5B, at 531, the N2 SM information carries information that the AMF 503 may forward to the W-AGF 502. The N2 SM information includes but is not limited to, at least one PDU Set QoS parameter to activate the PDU Set QoS handling for the given QoS flow. The N1 SM container that the AMF 503 may provide to the RG 501 (e.g., 5G-RG) includes but is not limited to, for each QoS flow for which the UL PDU Set QoS handling needs to be enabled, the protocol description for identifying the PDU Set information.

At 532, the AMF 503 may, based on a request by the SMF 504, send a N2 PDU session resource setup request message to the W-AGF 502 to establish one or more access resources (also simply referred to as “the access resources”) for the PDU session.

At 533, based on the QoS flows and/or the QoS parameters received in 512a-512b, the W-AGF 502 determines one or more corresponding PDU Set wireline QoS resources needed for the PDU session.

At 534, the W-AGF 502 sets up one or more W-UP resources (also simply referred to as “the W-UP resources”) for the PDU session.

At 535, after all the W-UP resources are set up, the W-AGF 502 may forward to the RG 501 (e.g., 5G-RG), via the W-CP signaling connection, the PDU session establishment accept message (including the protocol description associated with the QoS rules) received in 512b.

At 536, the W-AGF 502 may transmit, to the AMF 503, an N2 PDU session resource setup response including but not limited to: a PDU Set based handling support indication in N2 SM information.

At 537-538, the AMF 503 may transmit an Nsmf_PDUSession_UpdateSMContext request to the SMF 504, including the SM context ID, the N2 SM information, and/or the request type etc.

At 539-540, the SMF 504 may initiate an N4 session modification procedure with the UPF, provide AN tunnel information and transmit the rules. If redundant transmission is needed for one or more QoS flows, the SMF 504 may instruct the UPF to perform packet duplication in the downlink direction. In cases involving two I-UPFs for redundancy, the SMF 504 may provide the AN tunnel information to both I-UPFs and configure the PSA UPF for packet duplication, while exchanging tunnel information between them. If the PDU Set based handling support indication is included, the SMF 504 may configure the PSA UPF for PDU Set marking. After the UPF responds with an N4 session modification response, any buffered downlink packets may be transmitted to the RG (e.g., 5G-RG).

At 541-542, if the request type is neither the emergency request nor the existing emergency PDU session and the SMF 504 has not yet registered the PDU session, the SMF 504 may register with the UDM using Nudm_UECM_Registration, providing the key session information (e.g., the SUPI, the DNN, the S-NSSAI, the PDU Session ID, and/or the SMF identity, etc.). The UDM may store the information in the UDR. If event exposure subscriptions are applicable for this RG (e.g., 5G-RG), the UDM may initiate the Nsmf_EventExposure_Subscribe service. For the emergency requests, the SMF 504 may register with the UDM for authenticated non-roaming UEs, while for unauthenticated or roaming UEs, registration may not be performed.

At 543-544, the SMF 504 may respond to the AMF 503 with a cause for the PDU session context update. The SMF 504 may also subscribe to 5G-RG mobility events using the Namf_EventExposure_Subscribe service. If the PDU session establishment fails at any point, the SMF 504 may inform the AMF 503, release N4 sessions, any allocated PDU session addresses, and end the PCF association if applicable. For non-roaming subscribers, if no other PDU session uses the same S-NSSAI, the AMF 503 may start a slice deregistration inactivity timer.

At 545, for PDU session types IPV6 and/or IPv4v6, the SMF 504 may generate an IPV6 router advertisement for the RG 501 (e.g., 5G-RG).

At 546, when the trigger for 5GS bridge and/or router information becomes available, the SMF 504 may initiate an SM policy association modification.

At 547, if the PDU session establishment fails, the SMF 504 may unsubscribe from the session management subscription data, and the UDM may also unsubscribe from modification notifications.

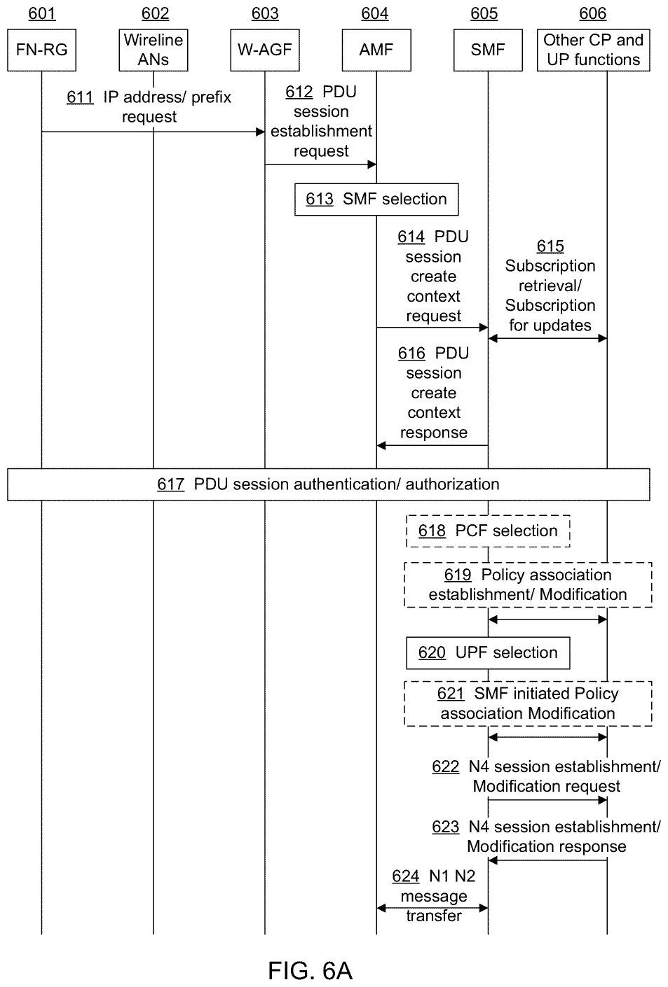

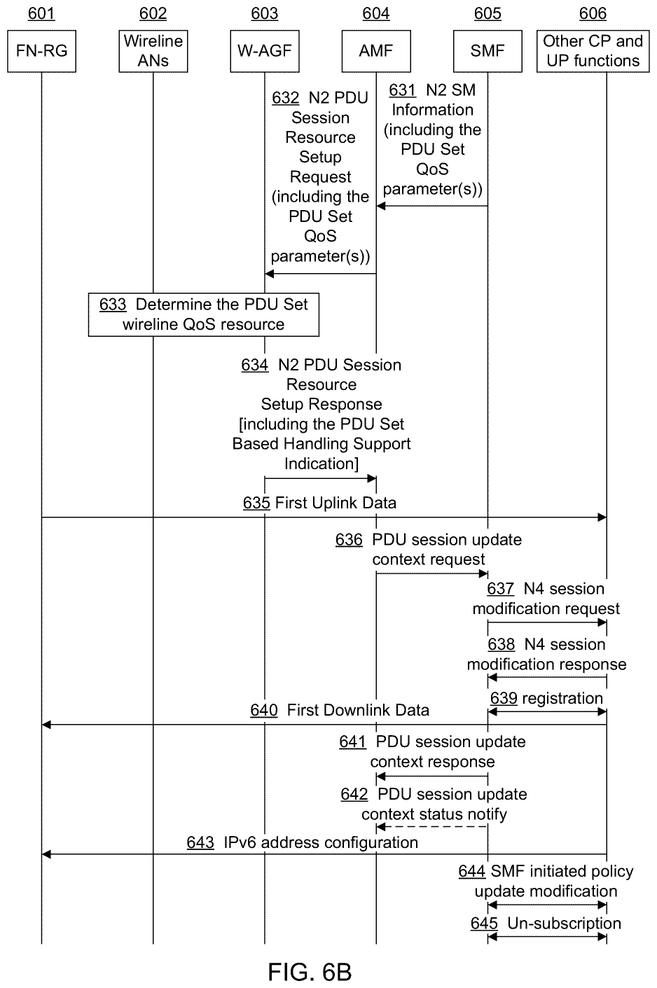

FIGS. 6A-6B illustrate a procedure for an example solution for the W-AGF and the RG (e.g., FN-RG), according to one or more embodiments. The procedure may be performed between an RG 601 (e.g., FN-RG), one or more wireline ANs 602, a W-AGF 603, an AMF 604, an SMF 605, and one or more other CP and/or UP functions 606. At 611, one or more processes associated with the RG 601 related PDU session establishment via the W-5GAN may be executed.

At 611, the RG 601 (e.g., FN-RG) may request the IP address and/or the prefix from the W-AGF via an L2 connection. The W-AGF 603, upon completing the registration procedure, may initiate the one or more PDU sessions on behalf of the RG 601 based on one or more local and/or 5GC-sourced configurations. The W-AGF 603 may generate a PDU session ID and/or one or more parameters such as but not limited to a PDU session type, the S-NSSAI, and/or the DNN etc., and may request deferred IP address allocation if DHCPv4/v6 requests are received.

At 612, the W-AGF 603 may transmit a NAS PDU establishment request to the AMF 604, including the relevant PDU session information and/or one or more identifiers for N3 terminations, which may be utilized by the SMF 605 to select the UPF.

At 613, the AMF 604 selects an SMF, e.g., the SMF 605. In that, the AMF 604 may determine and/or assign appropriate network slices (e.g., S-NSSAI) and DNN based on a RG subscription and one or more operator policies. The AMF 604 may select and/or replace the DNN, and/or may choose an appropriate SMF. The AMF 604 may also handle situations such as but not limited to handovers, error cases, and/or emergency session requests etc.

At 614, the AMF 604 may communicate with the SMF 605 via one or more of the requests: Nsmf_PDUSession_CreateSMContext for the new PDU sessions and/or Nsmf_PDUSession_UpdateSMContext for the existing PDU sessions. The requests may include information such as but not limited to the SUPI, the DNN, the S-NSSAI, a user location, an access type, a RAT type, and/or other parameters etc.

At 615, if the SMF 605 lacks session management subscription data for the given SUPI, the DNN, and/or the S-NSSAI etc., the SMF 605 may retrieve the session management subscription data from the UDM via a Nudm_SDM_Get and may subscribe for updates through a Nudm_SDM_Subscribe. The UDM may source the session management subscription data the from the UDR and may include session information such as but not limited to the allowed PDU types, the SSC modes, and/or the IP configuration etc. For non-roaming and/or specific use cases, the SMF 605 may apply the one or more local policies. The SMF 605 may verify the request against the subscription data and determine if redundancy and/or other special handling may be needed. If the request is invalid, the SMF 605 may reject the request and may signal a NAS SM with appropriate cause and possibly release the corresponding PDU session ID. If accepted, the SMF 605 may create and/or update the SM context and respond with a context ID to the AMF 604. Additionally, the SMF 605 may check if one or more security policies, such as integrity protection, need to be enforced based on the request's characteristics.

At 616, from the SMF 605 to the AMF 604, the response may be either the Nsmf_PDUSession_CreateSMContext response (indicating a cause, a SM context ID, and/or a PDU session reject etc.) and/or the Nsmf_PDUSession_UpdateSMContext response, based on the request received. If the SMF 605 processes the PDU session establishment request, the SMF 605 may create the SM context and transmit the SM context ID to the AMF 604. The SMF 605 may evaluate the UP security policy, and if the integrity protection is required, the SMF 605 may reject the PDU session request based on the RG integrity protection maximum data rate. If the request is rejected, the SMF 605 may inform the AMF 604 with the rejection cause and consider the PDU session ID released, halting the PDU session establishment procedure.

At 617, the secondary authentication and/or authorization may not be performed by the SMF 605 if the request indicates the existing PDU session and/or involves the emergency request and/or the existing emergency PDU session. However, if required during the establishment of the PDU session, the SMF 605 may trigger the secondary authentication and/or authorization via the DN-AAA server.

At 618, if a dynamic PCC is used for the PDU session, the SMF 605 may select the PCF. For the existing PDU session and/or existing emergency PDU session requests, the SMF 605 may use a previously selected PCF for the PDU session. In other cases, the SMF 605 may follow local policies for the PCF selection.

At 619, the SMF 605 may initiate the SM policy association establishment procedure with the PCF to obtain default PCC rules for the PDU session, including the 3GPP data off status, the GPSI, the PVS FQDN/IP addresses, and/or the S-NSSAI or the alternative S-NSSAI if available. For the existing PDU sessions, the SMF 605 may use the policy control request trigger conditions that have been met.

At 620, when the request type indicates an initial request, the SMF 605 may select the SSC mode and the necessary UPFs for the PDU session and allocate IP addresses and/or interface identifiers for IPV4, IPv6, and/or unstructured PDU sessions, as per the type. For the existing PDU sessions, the SMF 605 may maintain the same IP address, the PDU session anchor, and/or the SSC mode. In the case of emergency requests, the SMF 605 may select the UPF and the SSC mode 1.

At 621, the SMF 605 may initiate the policy association modification procedure to notify the PCF when specific policy control triggers are met, such as allocating the IP address to the RG (e.g., FN-RG) during the initial request for dynamic PCC deployment in IPV4, IPV6, and/or IPv4v6 PDU sessions. If the IP address has already been allocated, the notification may be skipped. Additionally, if the PCF has subscribed to the triggers, such as the RG reporting connection capabilities through URSP rules, the SMF 605 may report the capabilities and the PCF may update policies or generate the SDF templates in response. The mapping between the connection capabilities and the SDF templates may be implementation-specific.

At 622, when the request type indicates the initial request, the SMF 605 may initiate the N4 session establishment procedure with the selected UPFs and/or may initiate the N4 session modification. During this, the SMF 605 may transmit the N4 session establishment and/or modification request to the UPF, providing packet detection, enforcement, and/or reporting rules for the PDU session. The SMF 605 may request the IP address allocation, provide an inactivity timer, configure trace requirements, and/or manage small data rate control and serving PLMN rate control parameters. For specific PDU sessions (e.g., Ethernet and/or IP), the SMF 605 may request a port number, and if redundant transmission is required, the SMF 605 may manage tunnel information for duplication elimination. The SMF 605 may also perform functions such as interworking with the TSN, enabling the ECN marking, and including the DNN and the S-NSSAI for specific services.

At 623, the UPF may respond to the N4 session establishment and/or modification request by transmitting an acknowledgment, which may include the allocated IP address and/or prefix if requested. If packet duplication and elimination were indicated, the UPF may provide two CN tunnel information, and if redundant transmission is required, the UPF may allocate the CN tunnel information for two I-UPFs and the PSA UPF. The response may also include the port number and user-plane node ID for specific PDU sessions, supporting integration with the TSN and/or the DetNet networks. The SMF 605 may initiate this procedure with multiple UPFs if needed, and if interworking with the TSN is supported, the UPF may transmit a TL-Container in the response. The SMF 605 may also notify the PCF of the IP address change if subscribed.

At 624, the SMF 605 may transmit a Namf_Communication_N1N2MessageTransfer to the AMF 604, which includes key information for the PDU session establishment. The message may include the PDU session ID and the N2 SM information.

In FIG. 6B, at 631, the N2 SM information carries information that the AMF 604 may forward to the W-AGF 603. The N2 SM information includes but is not limited to at least one PDU Set QoS parameter to activate the PDU Set QoS handling for the given QoS flow.

At 632, the AMF 604 may, based on the request from the SMF 605, transmit the N2 PDU session resource setup request message to the W-AGF 603 to establish the access resources for the PDU session.

At 633, based on one or more policies, configuration and/or based on the QoS flows, the QoS parameters received in 612a-612b, the W-AGF 603 may determine the W-UP resources needed for the PDU session.

The W-AGF 603 may perform an access specific resource reservation with the ANs 602, that is, the W-AGF 603 sets up the W-UP resources for the PDU session.

At 634, the W-AGF 603 may transmit, to the AMF 604, the N2 PDU session resource setup response including: the PDU Set based handling support indication in the N2 SM information.

At 635-636, the AMF 604 may transmit an Nsmf_PDUSession_UpdateSMContext request to the SMF 605, including the SM context ID, the N2 SM information, and/or request type etc.

At 637-638, the SMF 605 may initiate the N4 session modification procedure with the UPF, provide the AN tunnel information and transmit the rules. If redundant transmission is needed for the one or more QoS flows, the SMF 605 may instruct the UPF to perform packet duplication in the downlink direction. In cases involving two I-UPFs for redundancy, the SMF 605 may provide the AN tunnel information to both I-UPFs and configure the PSA UPF for packet duplication, while exchanging tunnel information between them. If the PDU Set based handling support indication is included, the SMF 605 may configure the PSA UPF for PDU Set marking. After the UPF responds with an N4 session modification response, any buffered downlink packets may be transmitted to the RG 601 (e.g., FN-RG).

At 639-640, if the request type is neither the emergency request nor the existing emergency PDU session and the SMF 605 has not yet registered the PDU session, the SMF 605 may register with the UDM using Nudm_UECM_Registration, providing the key session information (e.g., the SUPI, the DNN, the S-NSSAI, the PDU Session ID, and/or the SMF identity, etc.). The UDM may store the information in the UDR. If the event exposure subscriptions are applicable for the RG 601 (e.g., FN-RG), the UDM may initiate the Nsmf_EventExposure_Subscribe service. For the emergency requests, the SMF 605 may register with the UDM for authenticated non-roaming UEs, while for unauthenticated or roaming UEs, registration may not be performed.

At 641-642, the SMF 605 may respond to the AMF 604 with the cause for the PDU session context update. The SMF 605 may also subscribe to the RG (e.g., 5G-RG and/or FN-RG) mobility events using the Namf_EventExposure_Subscribe service. If the PDU session establishment fails at any point, the SMF 605 may inform the AMF 604, release N4 sessions, any allocated PDU session addresses, and end the PCF association if applicable. For non-roaming subscribers, if no other PDU session uses the same S-NSSAI, the AMF 604 may start the slice deregistration inactivity timer.

At 643, for the PDU session types IPV6 and/or IPv4v6, the SMF 605 may generate the IPV6 router advertisement for the RG (e.g., 5G-RG and/or FN-RG).

At 644, when the trigger for 5GS bridge and/or router information becomes available, the SMF 605 may initiate the SM policy association modification.

At 645, If the PDU session establishment fails, the SMF 605 may unsubscribe from the session management subscription data, and the UDM may also unsubscribe from the modification notifications.

In an example, the SMF may transmit the protocol description associated with the QoS Rule to the RG (e.g., 5G-RG and/or FN-RG) over N1.

In an example, the W-AGF may map the PDU Set-enabled QoS profile to the corresponding W-UP resource.

In an example, the RG (e.g., 5G-RG and/or FN-RG) may map the PDU Set-enabled QoS rule to the corresponding W-UP resource.

In an example, a method for PDU Set identification based on the protocol description sent by the SMF over N1 is provided.

In an example, access traffic steering, switching, and/or switching (ATSSS) allows for best network selection, seamless handover, and/or network aggregation etc.

For the PDU Set handling, at an NG-RAN Xn handover and/or an N2 handover, a target NG-RAN provides to the SMF, an indication of whether the target NG-RAN provides the PDU Set based handling. Based on the target NG-RAN indication, the SMF may, upon completion of a handover procedure, initiate a PDU session modification procedure to provide the PDU Set QoS parameters to the NG-RAN and configure the PSA UPF to activate and/or deactivate the PDU Set identification and marking.

In case of the PDU Set handling with the ATSSS, when a traffic is switched from one access to another, in a scenario where one access supports the PDU Set based QoS handling while the other access does not, the SMF may initiate the PDU session modification procedure to provide the PDU Set QoS parameters and configure the PSA UPF to activate and/or deactivate the PDU Set identification and marking. Further, using the ATSSS, when the traffic is steered towards one access, in the scenario where the selected access supports the PDU Set based QoS handling, the SMF may initiate the PDU session modification procedure to provide the PDU Set QoS parameters and configure the PSA UPF to activate and/or deactivate the PDU Set identification and marking.

In various examples, one or more methods for low latency, low loss, and scalable throughput (L4S) in the wireline access are provided in the present disclosure. In that, there may be one or more mechanisms needed to support the L4S on the wireline access in the UL and/or DL directions, including supporting explicit congestion notification (ECN) marking for L4S traffic in the non-3GPP access and/or intermediate nodes of the W-AGF and/or the RG.

The W-5GAN connects to the 5GC via the W-AGF which interfaces with the 5GC CP and/or UP functions over N2 and/or N3 interfaces, respectively. The 5G-RG may authenticate, register and/or signal directly with the 5GC over the N1 interface, while for the FN-RG, which is not 5G capable, N1 is terminated on the W-AGF which functions on behalf of the FN-RG.

In an example, the one or more mechanisms to provide the QoS in the wireline networks may be different from those in the 5GS. In an example, in the W-5GCAN, a service flow is a MAC-layer transport service that provides unidirectional transport of one or more packets, such as one or more upstream packets transmitted by the CM and/or one or more downstream packets transmitted by the CMTS. The service flow may be characterized by a classifier and a set of QoS parameters such as latency, jitter, and/or throughput assurances etc. A classifier is a set of matching criteria applied to each packet entering a cable network which includes one or more packet matching criteria and a classifier priority. In an example, one or more downstream classifiers may be applied by the CMTS while one or more upstream classifiers may be applied at the CM. The cable access network provides support for one or more low-latency services through a dual-queue approach, by separating queue-building and non-queue-building traffic. In both the upstream and downstream directions, one or more low latency service flows are created with the associated classifiers. Therefore, the mechanism provides that the 3GPP-defined wireline nodes (e.g., the W-AGF and/or the RG) extend support for the L4S traffic in the W-5GAN.

In an example, one or more methods for supporting the L4S in the non-3GPP access are provided. In an example, the ECN marking may be used for the L4S to expose congestion information for the 3GPP access. The 5G system supports the ECN marking for the L4S in the NG-RAN and/or via the PSA UPF based on the NG-RAN congestion information monitoring. 5GS support on the L4S is limited to the NG-RAN access. However, interaction between the applications and/or the 5GS via the non-3GPP access is necessary to reduce latency, reduce congestion, and ensure desired experience for users. A user may be serviced by the 5GC via trusted and/or untrusted non-3GPP access. The user may be serviced by the 5GC via the wireline access such as a device behind the RG.

In an example, one or more mechanisms to support the L4S over the non-3GPP access are provided. In an example mechanism, the L4S traffic is supported on the untrusted and/or trusted accesses in the UL and/or the DL directions, including support for the ECN marking for the L4S in the non-3GPP access and intermediate gateways such as the N3IWF and/or the TNGF etc. In an example, an example mechanism supports the L4S on the wireline accesses in the UL and/or the DL directions, including supporting the ECN marking for the L4S in the non-3GPP access and the intermediate nodes such the W-AGF and/or the RG. In an example, an example mechanism supports the L4S with the ATSSS feature.

In the 5G system, the ECN marking for the L4S may be supported. The ECN marking for the L4S is enabled on a per QoS flow basis in the uplink and/or downlink directions and may be used for the GBR and/or the non-GBR QoS flows. The ECN marking for the L4S in an internet protocol (IP) header is supported in either the NG-RAN, or in the PSA UPF via the NG-RAN. In extending the ECN marking for the L4S via the wireline access, multiple components in a route of the IP packet via the wireline access may support the ECN marking. In the wireline access, the one or more wireline access nodes perform the ECN marking for the downlink and/or uplink directions. In the 5G systems, the 5G-RG performs the ECN marking for the downlink and/or the uplink directions. For the IP packet via the wireline access, the ECN marking may occur in any one or more components. In an example, congestion indication and marking by a component is performed only when the congestion indication has not been set by a previous component in the route. Depending on one or more capabilities of each component, the ECN marking on the route may be supported by a subset of the above, none of the above, and/or all the above.

For the wireline cable access network, such as DOCSIS, support for low-latency services is provided through the dual-queue approach, by separating the queue-building and the non-queue-building traffic. DOCSIS, such as low latency DOCSIS (LLD), also supports the ECN marking for the L4S, where the L4S traffic would be managed separately from other class traffic (e.g., a separate low latency service flow from one or more other classic service flows). In an example, the RG may be a bottleneck link experiencing local congestion. A last-mile congestion on a wireless local area network (WLAN) is not negligible and support of the L4S in last-mile route would provide considerable performance benefit. In an example, one or more methods to address this by allowing the RG to enable the ECN marking for the L4S is provided.

The ECN marking for the L4S in the W-5GAN is enabled on the per QoS flow basis in the UL and/or DL directions. In an example, one or more dedicated W-UP resources are used for carrying an L4S-enabled IP traffic. For the DL, the W-AGF maps the L4S-enabled QoS flows to the one or more W-UP resources. For the UL, the RG (e.g., 5G-RG) maps the L4S-enabled QoS flows to the one or more W-UP resources. The RG (e.g., 5G-RG) may enable the ECN marking for the L4S in the IP header of the user IP packets based on its local congestion information.

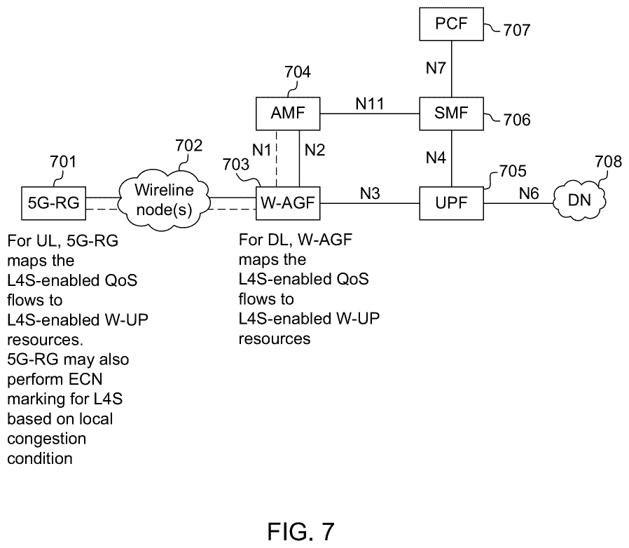

FIG. 7 illustrates an example architecture for the L4S support in the wireline access, according to one or more embodiments. The example architecture may include an RG 701 (e.g., 5G-RG), one or more wireline nodes 702, a W-AGF 703, an AMF 704, a UPF 705, an SMF 706, a PCF 707, and a data network (DN) 708.

In an example method for supporting the ECN marking for the L4S in the wireline nodes 702, in the DL direction, when the W-AGF 703 receives the one or more N2 requests related with the PDU session resources, the W-AGF 703 maps the one or more QoS profiles received from the 5GC to one or more W-UP QoS levels. The SMF 706 may be instructed, based on either dynamic and/or predefined PCC rules, to provide the indication for the L4S for the corresponding QoS flows to the W-AGF 703. The W-AGF 703 maps the L4S-enabled QoS flows to the L4S-enabled wireline QoS resources.

When the W-AGF 703 receives a DL PDU via N3, the W-AGF 703 identifies a QoS flow identifier (QFI) from the GTP-U header, and if the QFI corresponds to the QoS flow with the L4S enabled, the W-AGF 703 determines the corresponding L4S-enabled wireline QoS resource to use for sending the DL PDU to the RG.

In an example, in case of the UL, when the RG 701 (e.g., 5G-RG) receives the NAS message related with the PDU session QoS, the RG 701 maps the QoS rules received in the NAS to the W-UP QoS level. The SMF 706 may be instructed, based on either dynamic and/or predefined PCC rule, to provide the indication for the ECN marking for the L4S for the corresponding QoS flows to the RG 701. The RG 701 maps the L4S-enabled QoS flows to the L4S-enabled wireline QoS resources.

When the RG 701 (e.g., 5G-RG) transmits the UL PDU, if the RG 701 determines, by using the QoS rules of the PDU session, that the QFI corresponds to the QoS flow with the L4S enabled, the RG 701 determines the corresponding L4S-enabled wireline QoS resource to use for sending the UL PDU to the W-AGF 703.

In an example, a method for supporting the ECN marking for the L4S in the RG is provided. The RG (e.g., 5G-RG) may be requested by the SMF to perform the ECN marking for the L4S in the IP header of the user IP packets, based on one or more local congestion conditions, for those QoS flows for which the RG receives the indication for the L4S in the QoS rules via the NAS message. The criteria based on which the RG decides to mark one or more ECN bits for the L4S may be RG implementation specific.

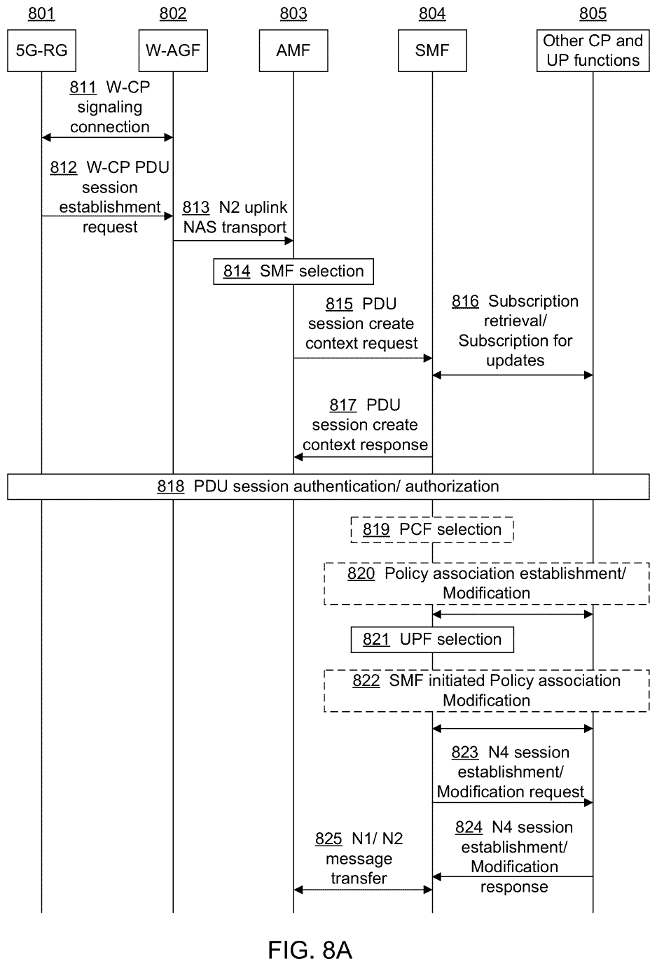

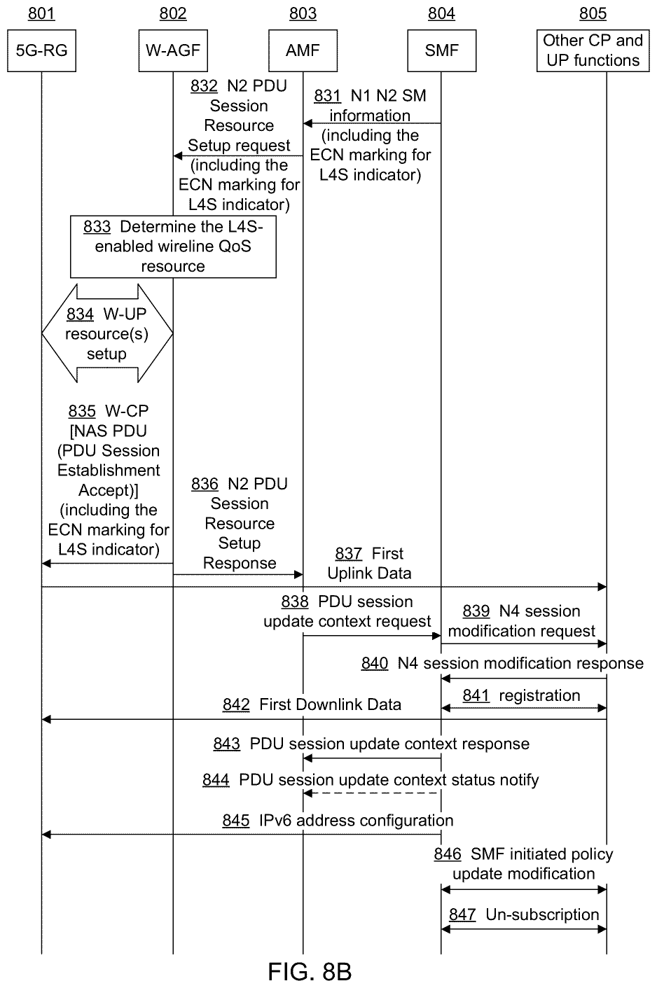

FIGS. 8A-8B illustrate an example procedure for the L4S support in the wireline access, according to the one or more embodiments. The procedure may be implemented by a RG 801 (e.g., 5G-RG), a W-AGF 802, an AMF 803, an SMF 804, and one or more other CP and/or UP functions 805.

At 811, the RG 801 (e.g., 5G-RG) and the W-AGF 802 may establish the W-CP signaling connection.

At 812-813, the RG 801 (e.g., 5G-RG) transmits the PDU session establishment request message to the AMF 803 via the W-AGF 802. At 812, the PDU session establishment request message may be transmitted to the W-AGF 802 via the W-CP signaling connection. At 813, the W-AGF 802 may transparently forward the PDU session establishment request message in the N2 uplink NAS transport message (e.g., NAS message, user location information, W-AGF identities etc.) to the AMF 803 in the 5GC.

At 814, the AMF 803 selects an SMF, e.g., the SMF 804. In that, the AMF 803 may determine and/or assign appropriate network slices (e.g., the S-NSSAI) and the DNN based on the RG subscription and one or more operator policies. The AMF 803 may select and/or replace the DNN, and/or may choose an appropriate SMF. The AMF 803 may also handle situations such as but not limited to the handovers, the error cases, and/or the emergency session requests etc.

At 815, the AMF 803 may communicate with the SMF 804 via one or more of the requests: Nsmf_PDUSession_CreateSMContext for the new PDU sessions and/or Nsmf_PDUSession_UpdateSMContext for the existing PDU sessions. The requests may include information such as but not limited to the SUPI, the DNN, the S-NSSAI, the user location, the access type, the RAT type, and/or other parameters etc.

At 816, if the SMF 804 lacks session management subscription data for the given SUPI, the DNN, and/or the S-NSSAI etc., the SMF 804 may retrieve the session management subscription data from the UDM via a Nudm_SDM_Get and may subscribe for updates through a Nudm_SDM_Subscribe. The UDM may source the session management subscription data from the UDR and may include session information such as but not limited to the allowed PDU types, the SSC modes, and/or the IP configuration etc. For non-roaming and/or specific use cases, the SMF 804 may apply one or more local policies. The SMF 804 may verify the request against the subscription data and determine if redundancy and/or other special handling may be needed. If the request is invalid, the SMF 804 may reject the request and may signal the NAS SM with appropriate cause and possibly release the corresponding PDU session ID. If accepted, the SMF 804 may create and/or update the SM context and respond with the context ID to the AMF 803. Additionally, the SMF 804 may check if one or more security policies, such as integrity protection, need to be enforced based on the characteristics of the request.

At 817, from the SMF 804 to the AMF 803, the response may be either a Nsmf_PDUSession_CreateSMContext response (indicating a cause, a SM context ID, and/or a PDU session reject etc.) and/or an Nsmf_PDUSession_UpdateSMContext response, based on the request received. If the SMF 804 processes the PDU session establishment request, the SMF 804 may create the SM context and transmit the SM context ID to the AMF 803. The SMF 804 may evaluate the UP security policy, and if the integrity protection is required, the SMF 804 may reject the PDU session request based on the RG integrity protection maximum data rate. If the request is rejected, the SMF 804 may inform the AMF 803 with the rejection cause and consider the PDU session ID released, halting the PDU session establishment procedure.

At 818, the secondary authentication and/or authorization may not be performed by the SMF 804 if the request indicates the existing PDU session and/or involves the emergency request and/or the existing emergency PDU session. However, if required during the establishment of the PDU session, the SMF 804 may trigger the secondary authentication and/or authorization via the DN-AAA server.

At 819, if a dynamic PCC may be used for the PDU session, the SMF 804 may select the PCF. For the existing PDU session and/or existing emergency PDU session requests, the SMF 804 may use the previously selected PCF for the PDU session. In other cases, the SMF 804 may follow the local policies for the PCF selection.

At 820, the SMF 804 may initiate the SM policy association establishment procedure with the PCF to obtain the default PCC rules for the PDU session, including the 3GPP data off status, the GPSI, the PVS FQDN/IP addresses, and/or the S-NSSAI or the alternative S-NSSAI if available. For the existing PDU sessions, the SMF 804 may use policy control request trigger conditions that have been met.

At 821, when the request type indicates the initial request, the SMF 804 may select the SSC mode and the necessary UPFs for the PDU session and allocate the IP addresses and/or interface identifiers for IPV4, IPV6, and/or unstructured PDU sessions, as per the type. For the existing PDU sessions, the SMF 804 may maintain the same IP address, PDU session anchor, and/or SSC mode. In the case of emergency requests, the SMF 804 may select the UPF and SSC mode 1.

At 822, the SMF 804 may initiate the policy association modification procedure to notify the PCF when the specific policy control triggers are met, such as allocating the IP address to the RG (e.g., 5G-RG) during the initial request for dynamic PCC deployment in IPV4, IPV6, and/or IPv4v6 PDU sessions etc. If the IP address has already been allocated, the notification may be skipped. Additionally, if the PCF has subscribed to the triggers, such as the RG reporting connection capabilities through the URSP rules, the SMF 804 may report the capabilities and the PCF may update policies and/or generate the SDF templates in response. The mapping between connection capabilities and the SDF templates may be implementation-specific.

At 823, when the request type indicates the initial request, the SMF 804 may initiate the N4 session establishment procedure with the selected UPFs and/or may initiate the N4 session modification. During this, the SMF 804 may transmit the N4 session establishment and/or modification request to the UPF, providing packet detection, enforcement, and/or reporting rules for the PDU session. The SMF 804 may request the IP address allocation, provide an inactivity timer, configure trace requirements, and/or manage small data rate control and serving PLMN rate control parameters. For specific PDU sessions (e.g., Ethernet and/or IP), the SMF 804 may request the port number, and if redundant transmission is required, the SMF 804 may manage tunnel information for duplication elimination. The SMF 804 may also perform functions such as interworking with the TSN, enabling the ECN marking, and including the DNN and the S-NSSAI for specific services.

At 824, the UPF may respond to the N4 session establishment and/or modification request by transmitting the acknowledgment, which may include the allocated IP address and/or prefix if requested. If packet duplication and elimination were indicated, the UPF may provide two CN tunnel information, and if redundant transmission is required, the UPF may allocate the CN tunnel information for two I-UPFs and the PSA UPF. The response may also include the port number and user-plane node ID for specific PDU sessions, supporting integration with the TSN and/or the DetNet networks. The SMF 804 may initiate this procedure with multiple UPFs if needed, and if interworking with the TSN is supported, the UPF may transmit a TL-Container in the response. The SMF 804 may also notify the PCF of the IP address change if subscribed.

At 825, the SMF 804 may transmit a Namf_Communication_N1N2MessageTransfer to the AMF 803, which includes key information for the PDU session establishment. The message may include the PDU session ID and the N2 SM information.

In FIG. 8B, at 831, the N2 SM information carries information that the AMF 803 may forward to the W-AGF 802 which includes, for each QoS flow, the ECN marking for the L4S indicator to the W-5GAN in the case of the ECN marking for the L4S in the W-5GAN.

The N1 SM container that the AMF 803 may provide to the RG 801 (e.g., 5G-RG) includes, for each QoS flow, the ECN marking for the L4S indicator to the RG 801 in the case of the ECN marking for the L4S in the RG 801, if the RG 801 indicates support for the ECN marking for the L4S.

At 832, the AMF 803 may, based on the request by the SMF 804, transmit the N2 PDU session resource setup request message, which includes the ECN marking for the L4S indicator, to the W-AGF 802 to establish the access resources for the PDU session.

At 833, based on the QoS flows and/or the QoS parameters received at 812a-812b, the W-AGF 802 determines the corresponding L4S-enabled wireline QoS resources needed for the PDU session.

At 834, the W-AGF 802 sets up the W-UP resources for the PDU session.

At 835, after all the W-UP resources are established, the W-AGF 802 may forward to the RG 801 (e.g., 5G-RG) via the W-CP signaling connection the PDU session establishment accept message (including the ECN marking for the L4S indicator) received at 812b.

At 836, the W-AGF 802 may transmit to the AMF 803 the N2 PDU session resource setup response including but not limited to an established QoS flow status (e.g., active and/or not active etc.) for the ECN marking for the L4S in the wireline access.

At 837-838, the AMF 803 may transmit an Nsmf_PDUSession_UpdateSMContext request to the SMF 804, including the SM context ID, the N2 SM information, and the request type.

At 839-840, the SMF 804 may initiate the N4 session modification procedure with the UPF, provide the AN tunnel information and transmit the rules. If redundant transmission is needed for the one or more QoS flows, the SMF 804 may instruct the UPF to perform packet duplication in the downlink direction. In cases involving two I-UPFs for redundancy, the SMF 804 may provide the AN tunnel information to both I-UPFs and configure the PSA UPF for packet duplication, while exchanging tunnel information between them. If the PDU Set based handling support indication is included, the SMF 804 may configure the PSA UPF for PDU Set marking. After the UPF responds with the N4 session modification response, any buffered downlink packets may be transmitted to the RG (e.g., 5G-RG).

At 841-842, if the request type is neither the emergency request nor the existing emergency PDU session and the SMF 804 has not yet registered the PDU session, the SMF 804 may register with the UDM using Nudm_UECM_Registration, providing the key session information (e.g., the SUPI, the DNN, the S-NSSAI, the PDU Session ID, and/or the SMF identity etc.). The UDM may store the information in the UDR. If event exposure subscriptions are applicable for the RG (e.g., 5G-RG), the UDM may initiate the Nsmf_EventExposure_Subscribe service. For the emergency requests, the SMF 804 may register with the UDM for authenticated non-roaming UEs, while for unauthenticated or roaming UEs, registration may not be performed.

At 843-844, the SMF 804 may respond to the AMF 503 with the cause for the PDU session context update. The SMF 804 may also subscribe to the RG mobility events using the Namf_EventExposure_Subscribe service. If the PDU session establishment fails at any point, the SMF 804 may inform the AMF 803, release N4 sessions, any allocated PDU session addresses, and end the PCF association if applicable. For non-roaming subscribers, if no other PDU session uses the same S-NSSAI, the AMF 803 may start the slice deregistration inactivity timer.

At 845, for PDU session types IPV6 and/or IPv4v6, the SMF 804 may generate the IPV6 router advertisement for the RG (e.g., 5G-RG).

At 846, when the trigger for 5GS bridge and/or router information becomes available, the SMF 804 may initiate the SM policy association modification.

At 847, If the PDU session establishment fails, the SMF 804 may unsubscribe from the session management subscription data, and the UDM may also unsubscribe from the modification notifications.

In an example, the SMF may provide the indication of the ECN marking for the L4S to the RG (e.g., 5G-RG) over N1.

In an example, the W-AGF may perform the mapping of the L4S-enabled QoS profile to the L4S-enabled W-UP resource.

In an example, the RG (e.g., 5G-RG) may map the L4S-enabled QoS rule to the L4S-enabled the W-UP resource.

In an example, the ECN marking for the L4S may be provided in the IP header of the user IP packets, such as the indication of support for the ECN marking for the L4S during a PDU session establishment request.

In an example, one or more methods for the L4S with the ATSSS are provided. The ATSSS allows for best network selection, seamless handover, and/or network aggregation, respectively.

In the L4S handling, when a serving PSA UPF and/or the NG-RAN is changed e.g., due to inter-NG-RAN handover and/or the PSA UPF relocation, the target NG-RAN and/or the target PSA UPF may continue contributing to the ECN marking for the L4S for the QoS flow. However, if not available, i.e. the ECN marking for the L4S is not supported in both, the target NG-RAN and/or the target PSA UPF, the AF may be notified.

For the QoS support, the 5G QoS model for a single-access PDU session is also applied to a MA PDU session, such as the QoS flow is the finest granularity of a QoS differentiation in the MA PDU session. A difference compared to the single-access PDU session is that in a MA PDU session there may be separate user-plane tunnels between the AN and the PSA, each one associated with a different access. However, the QoS flow is not associated with a specific access, such as the QoS flow is access agnostic, so the same QoS is supported when the traffic is distributed over the 3GPP and/or non-3GPP accesses. The SMF may provide the same QFI in the 3GPP and/or non-3GPP accesses so that the same QoS is supported in both accesses.

For ATSSS QoS support, in an example, the same QoS parameter may apply to a QoS flow regardless of the access (e.g., the 3GPP access and/or the non-3GPP etc.) for the MA-PDU session. For ECN marking for the L4S, in an example, the ECN marking and/or the L4S may be enabled at a QoS flow level. For example, in a scenario where the MA-PDU is established over a first 3GPP access and a second non-3GPP access, there may be a case where only one of the first 3GPP access and the second non-3GPP access may support the ECN marking (e.g., either the first 3GPP access gNB and/or NG-RAN supports the ECN or the second non-3GPP access wireline and/or WLAN or non-3GPP in general supports the ECN marking for the L4S). There is also the case where the first 3GPP access supports the L4S via the PSA UPF by congestion monitoring of the NG-RAN for the first 3GPP access while the second non-3GPP access may not support the L4S feature (e.g., either the ECN marking and/or congestion monitoring and/or exposure to the PSA etc.) or may support only the ECN marking at the access level. There are cases where the L4S support by the first 3GPP access (and/or the ECN marking via the PSA UPF via the first 3GPP access) and the second non-3GPP access (and/or the ECN marking via the PSA UPF via the second non-3GPP access) may not be aligned.

In a first example case, one access (e.g., the first access) supports the RAN and/or AN level ECN marking while the other access (e.g., the second access) does not support either the RAN and/or AN level or the PSA UPF level ECN marking.

In a second example case, one access (e.g., the first access) supports the RAN and/or AN level ECN marking while the other (e.g., the second access) only supports the PSA UPF level ECN marking.

In a third example case, one access (e.g., the first access) supports the PSA UPF ECN marking while the other access (e.g., the second access) does not support either the RAN and/or AN level or the PSA UPF level ECN marking.

When such capability discrepancy exists, the QoS flow with same QFI value may not behave equally in both accesses from the ECN marking to support the L4S. To address this, there may be various approaches for the first and/or second example cases.

In the first example case, the ECN marking for the L4S may be configured as the ECN marking at the RAN and/or AN level.

In an example, the UE/5G-RG may establish a first PDU session of the MA-PDU session via the first access that supports the RAN and/or AN level ECN marking, where the SMF establishes the QoS flow over the first PDU session to enable the ECN marking for the L4S via the first access. The UE/5G-RG may further establish a second PDU session of the MA-PDU session via the second access once the UE/5G-RG establishes the first PDU session where the second access does not support the ECN marking of the L4S (and/or may not know a capability of the second access). In this case, in an example, the SMF may reject the second PDU session as the second PDU session may also be required to support the ECN marking for the L4S while the second PDU session cannot. In an example, the SMF may grant the second PDU session, and disable the ECN marking for the L4S of the QoS flow by updating the QoS flow configured with the ECN marking for the L4S (e.g., by disabling the ECN marking for the QoS flow). In an example, if there are more than one QoS flows assigned with the ECN marking, the SMF may disable the L4S for the more than one QoS flows of the first PDU session, in this case, the SMF may inform application server and/or the AF that the L4S has been disabled correspondingly. In an example, the SMF may grant the second PDU session only when the ATSSS is configured with the steering and/or the switching and/or a repetition (e.g., not configured with the splitting). The SMF may indicate the AF when the steering and/or the switching occurs and/or the first access is not reachable (and thus the L4S is no longer supported) that the L4S is not supported any longer.

In an example, when the UE/5G-RG establishes the first PDU session of the MA-PDU session via the second access that does not support the L4S, and thus configures the QoS flow without the ECN enabled for the first PDU session, the UE/5G-RG may establish the second PDU session of the MA-PDU session via the first access that supports the L4S. In an example, the SMF may grant the second PDU session without configuring the ECN for the L4S of the QoS flow of the second PDU session. In an example, the L4S may not be supported for the MA-PDU session in this case. In an example, the SMF may grant the second PDU session with enabling the ECN for the L4S for the QoS flow via the first access. In an example, the SMF may inform whether the L4S is enabled or not for the QoS flow based on an active access of the MA-PDU session (e.g., if the MA-PDU is configured with the switching and currently the second access is active for the MA-PDU session, then SMF may inform the AF that the L4S is disabled, otherwise if the first access is active, the SMF may inform the AF that the L4S is enabled.

In the second example case, the ECN marking for the L4S may be configured as the ECN marking at the RAN and/or AN level. In an example, when the UE/5G-RG establishes the first PDU session of the MA-PDU session via the first access that supports the RAN and/or AN level ECN marking, where the SMF establishes the QoS flow over the first PDU session to enable the ECN marking for the L4S via the first access, the UE/5G-RG may establish the second PDU session of the MA-PDU session via the second access once the UE/5G-RG establishes the first PDU session where the second access does not support the ECN marking of the L4S at the RAN and/or AN. In an example, in this case, the SMF may, if the first access supports the ECN marking at the PSA UPF, change the ECN mechanism of the QoS flow from the RAN and/or AN to the PSA UPF, and grant the second PDU session. In an example, the SMF may maintain the ECN marking at the RAN and/or AN for the first access, grant the second PDU session, and configure the ECN marking at the PSA UPF for the QoS flow of the second PDU session via the second access. In an example, the SMF may inform the AF which ECN marking is used based on an active access for the MA-PDU session (e.g., when the switching and/or steering occurs and thus changes the active access, inform the ECN marking mechanism has been changed etc.).

In an example, when the UE/5G-RG establishes the first PDU session of the MA-PDU session via the second access that supports the ECN marking at the PSA UPF, and thus configures the QoS flow with the ECN marking at the PSA UPF for the first PDU session, the UE/5G-RG may establish the second PDU session of the MA-PDU session via the first access that supports the ECN at the RAN and/or AN. In an example, the SMF may, if the first access supports the ECN marking at the PSA UPF, configure the QoS flow with the ECN marking at the PSA UPF for the first access and/or the second PDU session, and grant the second PDU session. In an example, the SMF may grant the second PDU session, and configure the ECN marking at the RAN and/or AN level ECN marking for the QoS flow of the second PDU session via the first access. In an example, the SMF may inform the AF which ECN marking is used based on the active access for the MA-PDU session (e.g., when switching and/or steering occurs and thus changes the active access, inform the ECN marking mechanism has been changed).

As the configuration indicates the ECN marking at the RAN and/or AN level, the SMF may not grant the PDU session via the second access regardless whether the PDU session occurs first or second. In an example, the SMF may inform the AF and/or the PCF about the changes of the ECN marking to the PSA UPF in this case.

In the third example case, the ECN marking for the L4S may be configured as the ECN marking at the RAN and/or AN level.

In an example, when the UE/5G-RG establishes the first PDU session of the MA-PDU session via the first access that supports the RAN and/or AN level ECN marking, where the SMF establishes the QoS flow over the first PDU session to enable the ECN marking for the L4S via the first access, the UE/5G-RG may establish the second PDU session of the MA-PDU session via the second access once the UE/5G-RG establishes the first PDU session where the second access does not support the ECN marking of the L4S at the RAN. As the first access supports only the PSA UPF ECN marking which is different from the configured L4S policy, the SMF may inform the PCF and/or AF about the policy change. In this case, the SMF may reject the second PDU session as the second PDU session may also be required to support the ECN marking for the L4S while the second PDU session cannot. In an example, the SMF may grant the second PDU session, and disable the ECN marking for the L4S of the QoS flow by updating the QoS flow configured with the ECN marking for the L4S (e.g., by disabling the ECN marking for the QoS flow). In an example, if there are more than one QoS flows assigned with the ECN marking, the SMF may disable the L4S for the more than one QoS flows of the first PDU session, in this case, the SMF may inform application server and/or the AF that the L4S has been disabled correspondingly. In an example, the SMF may grant the second PDU session only when the ATSSS is configured with the steering and/or the switching and/or the repetition (e.g., not configured with the splitting). The SMF may indicate the AF when the steering and/or the switching occurs or the first access is not reachable (and thus the L4S is no longer supported) that the L4S is not supported any longer.

In an example, when the UE/5G-RG establishes the first PDU session of the MA-PDU session via the second access that does not support the L4S, and thus configures the QoS flow without the ECN enabled for the first PDU session, the UE/5G-RG may establish the second PDU session of the MA-PDU session via the first access that supports the L4S. In an example, in this case, the SMF may grant the second PDU session without configuring the ECN for the L4S of the QoS flow of the second PDU session. In an example, if no L4S is supported for the MA-PDU session, in this case, the SMF may grant the second PDU session by enabling the ECN for the L4S for the QoS flow via the first access. In an example, the SMF may inform whether the L4S is enabled or not for the QoS flow based on the active access of the MA-PDU session (e.g., if the MA-PDU is configured with switching and currently the second access is active for the MA-PDU session, then the SMF informs the AF that the L4S is disabled, otherwise if the first access is active, the SMF informs the AF that L4S is enabled.

In the third example case, assuming the ECN marking for the L4S is configured as the ECN marking at the PSA UPF, this case is similar to the above case except that the SMF may not inform about the L4S policy change as it follows the configuration.

In an example, in case the ECN marking for the L4S is configured as the PSA UPF and/or the RAN and/or AN, and both the accesses support or not support, a unified policy for the L4S may be configured for the QoS flow for the both accesses.

It may be noted that similar mechanisms may be applied to the PDU Set handling where the ECN marking for the L4S may be replaced by a support of the PDU Set.

In case of the L4S handling with the ATSSS, when the traffic is switched from one access to another, in the scenario where the first access supports the L4S handling while the second access does not, the AF may be notified that the L4S is no longer (and/or can again be) supported. In an example, using the ATSSS, when the traffic is steered toward one access, in the scenario where the selected access does not support the L4S handling, the AF may be notified that the L4S is no longer (or may again be) supported.

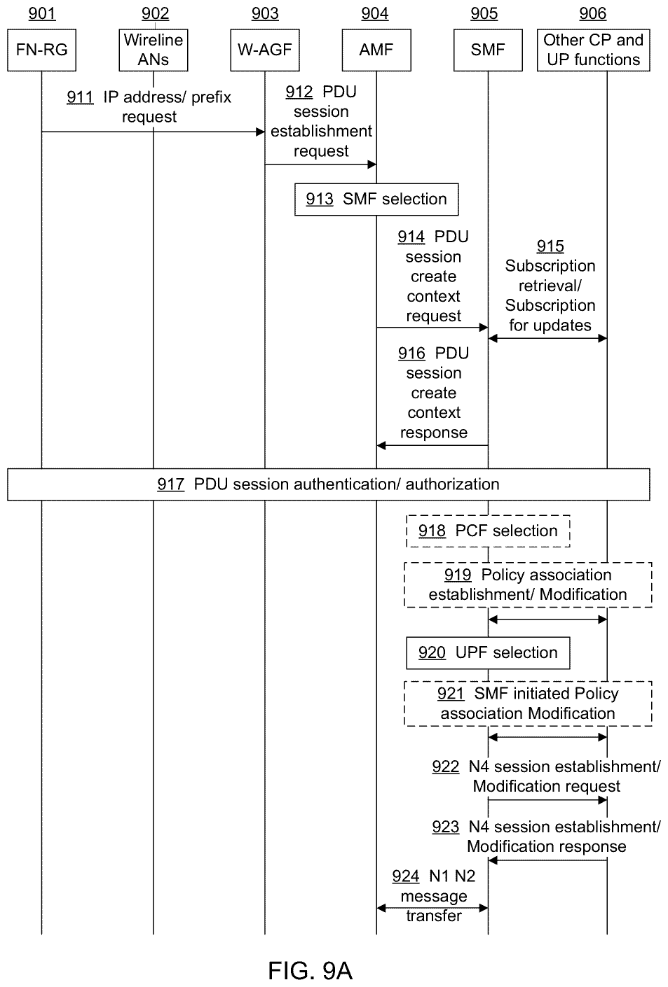

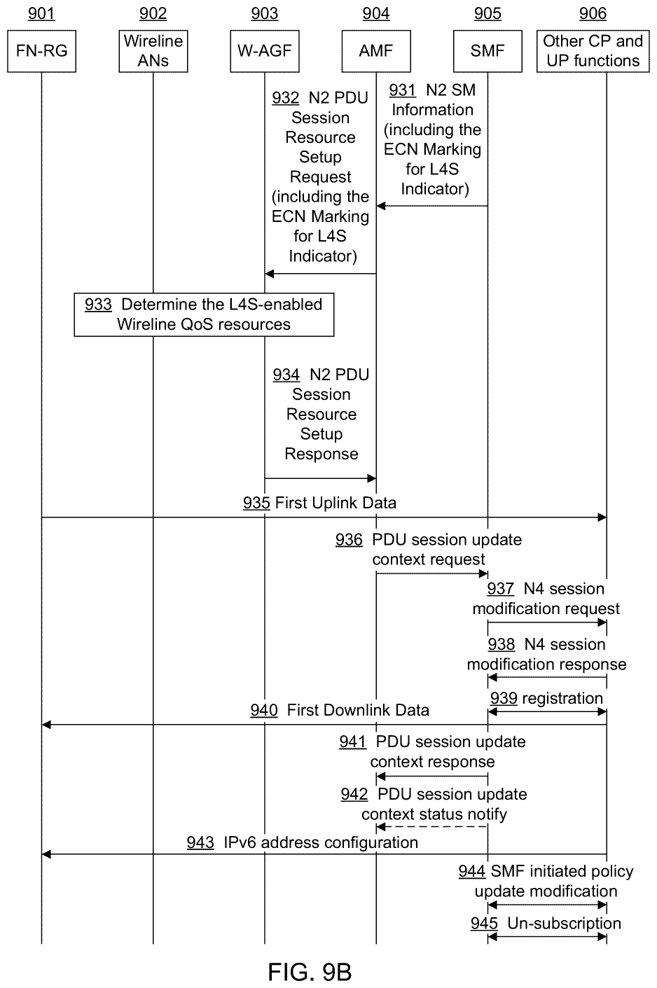

FIGS. 9A-9B illustrate a procedure for an example solution for the W-AGF and the RG (e.g., FN-RG), according to one or more embodiments. The procedure may be performed between an RG 901 (e.g., FN-RG), one or more wireline ANs 902, a W-AGF 903, an AMF 904, an SMF 905, and one or more other CP and/or UP functions 906. At 911, one or more processes associated with the RG 901 related PDU session establishment via the W-5GAN may be executed.

At 911, the RG 901 (e.g., FN-RG) may request the IP address and/or the prefix from the W-AGF via an L2 connection. The W-AGF 903, upon completing the registration procedure, may initiate the one or more PDU sessions on behalf of the RG 901 based on one or more local and/or 5GC-sourced configurations. The W-AGF 903 may generate a PDU session ID and/or one or more parameters such as but not limited to a PDU session type, the S-NSSAI, and/or the DNN etc., and may request deferred IP address allocation if DHCPv4/v6 requests are received.

At 912, the W-AGF 903 may transmit a NAS PDU establishment request to the AMF 904, including the relevant PDU session information and/or one or more identifiers for N3 terminations, which may be utilized by the SMF 905 to select the UPF.

At 913, the AMF 904 selects an SMF, e.g., the SMF 905. In that, the AMF 904 may determine and/or assign appropriate network slices (e.g., S-NSSAI) and DNN based on a RG subscription and one or more operator policies. The AMF 904 may select and/or replace the DNN, and/or may choose an appropriate SMF. The AMF 904 may also handle situations such as but not limited to handovers, error cases, and/or emergency session requests etc.

At 914, the AMF 904 may communicate with the SMF 905 via one or more of the requests: Nsmf_PDUSession_CreateSMContext for the new PDU sessions and/or Nsmf_PDUSession_UpdateSMContext for the existing PDU sessions. The requests may include information such as but not limited to the SUPI, the DNN, the S-NSSAI, a user location, an access type, a RAT type, and/or other parameters etc.

At 915, if the SMF 905 lacks session management subscription data for the given SUPI, the DNN, and/or the S-NSSAI etc., the SMF 905 may retrieve the session management subscription data from the UDM via a Nudm_SDM_Get and may subscribe for updates through a Nudm_SDM_Subscribe. The UDM may source the session management subscription data the from the UDR and may include session information such as but not limited to the allowed PDU types, the SSC modes, and/or the IP configuration etc. For non-roaming and/or specific use cases, the SMF 905 may apply the one or more local policies. The SMF 905 may verify the request against the subscription data and determine if redundancy and/or other special handling may be needed. If the request is invalid, the SMF 905 may reject the request and may signal a NAS SM with appropriate cause and possibly release the corresponding PDU session ID. If accepted, the SMF 905 may create and/or update the SM context and respond with a context ID to the AMF 904. Additionally, the SMF 905 may check if one or more security policies, such as integrity protection, need to be enforced based on the request's characteristics.

At 916, from the SMF 905 to the AMF 904, the response may be either the Nsmf_PDUSession_CreateSMContext response (indicating a cause, a SM context ID, and/or a PDU session reject etc.) and/or the Nsmf_PDUSession_UpdateSMContext response, based on the request received. If the SMF 905 processes the PDU session establishment request, the SMF 905 may create the SM context and transmit the SM context ID to the AMF 904. The SMF 605 may evaluate the UP security policy, and if the integrity protection is required, the SMF 905 may reject the PDU session request based on the RG integrity protection maximum data rate. If the request is rejected, the SMF 905 may inform the AMF 904 with the rejection cause and consider the PDU session ID released, halting the PDU session establishment procedure.

At 917, the secondary authentication and/or authorization may not be performed by the SMF 905 if the request indicates the existing PDU session and/or involves the emergency request and/or the existing emergency PDU session. However, if required during the establishment of the PDU session, the SMF 905 may trigger the secondary authentication and/or authorization via the DN-AAA server.

At 918, if a dynamic PCC is used for the PDU session, the SMF 905 may select the PCF. For the existing PDU session and/or existing emergency PDU session requests, the SMF 905 may use a previously selected PCF for the PDU session. In other cases, the SMF 905 may follow local policies for the PCF selection.

At 919, the SMF 905 may initiate the SM policy association establishment procedure with the PCF to obtain default PCC rules for the PDU session, including the 3GPP data off status, the GPSI, the PVS FQDN/IP addresses, and/or the S-NSSAI or the alternative S-NSSAI if available. For the existing PDU sessions, the SMF 905 may use the policy control request trigger conditions that have been met.

At 920, when the request type indicates an initial request, the SMF 905 may select the SSC mode and the necessary UPFs for the PDU session and allocate IP addresses and/or interface identifiers for IPV4, IPv6, and/or unstructured PDU sessions, as per the type. For the existing PDU sessions, the SMF 905 may maintain the same IP address, the PDU session anchor, and/or the SSC mode. In the case of emergency requests, the SMF 905 may select the UPF and the SSC mode 1.

At 921, the SMF 905 may initiate the policy association modification procedure to notify the PCF when specific policy control triggers are met, such as allocating the IP address to the RG (e.g., FN-RG) during the initial request for dynamic PCC deployment in IPV4, IPV6, and/or IPv4v6 PDU sessions. If the IP address has already been allocated, the notification may be skipped. Additionally, if the PCF has subscribed to the triggers, such as the RG reporting connection capabilities through URSP rules, the SMF 905 may report the capabilities and the PCF may update policies or generate the SDF templates in response. The mapping between the connection capabilities and the SDF templates may be implementation-specific.

At 922, when the request type indicates the initial request, the SMF 905 may initiate the N4 session establishment procedure with the selected UPFs and/or may initiate the N4 session modification. During this, the SMF 905 may transmit the N4 session establishment and/or modification request to the UPF, providing packet detection, enforcement, and/or reporting rules for the PDU session. The SMF 905 may request the IP address allocation, provide an inactivity timer, configure trace requirements, and/or manage small data rate control and serving PLMN rate control parameters. For specific PDU sessions (e.g., Ethernet and/or IP), the SMF 905 may request a port number, and if redundant transmission is required, the SMF 905 may manage tunnel information for duplication elimination. The SMF 905 may also perform functions such as interworking with the TSN, enabling the ECN marking, and including the DNN and the S-NSSAI for specific services.

At 923, the UPF may respond to the N4 session establishment and/or modification request by transmitting an acknowledgment, which may include the allocated IP address and/or prefix if requested. If packet duplication and elimination were indicated, the UPF may provide two CN tunnel information, and if redundant transmission is required, the UPF may allocate the CN tunnel information for two I-UPFs and the PSA UPF. The response may also include the port number and user-plane node ID for specific PDU sessions, supporting integration with the TSN and/or the DetNet networks. The SMF 905 may initiate this procedure with multiple UPFs if needed, and if interworking with the TSN is supported, the UPF may transmit a TL-Container in the response. The SMF 905 may also notify the PCF of the IP address change if subscribed.

At 924, the SMF 905 may transmit a Namf_Communication_N1N2MessageTransfer to the AMF 904, which includes key information for the PDU session establishment. The message may include the PDU session ID and the N2 SM information.

In FIG. 9B, at 931, the N2 SM information carries information that the AMF 904 may forward to the W-AGF 903. The N2 SM information carries information that the AMF 904 may forward to the W-AGF 903 which may include: for each QoS flow, an ECN marking for L4S indicator to W-5GAN in the case of ECN marking for L4S in W-5GAN.

At 932, the AMF 904 may, under request of the SMF 905, transmit a N2 PDU session resource setup request message, which includes the ECN marking for L4S indicator, to the W-AGF 903 to establish the access resources for this PDU session.

At 933, based on one or more own policies, configuration and based on the QoS flows, QoS parameters received in 931, the W-AGF 903 may determine the corresponding L4S-enabled wireline QoS resource needed for the PDU session. The W-AGF 903 may perform access specific resource reservation with the AN, that is, the W-AGF 903 sets up the W-UP resources for the PDU session.

At 934, the W-AGF 903 may transmit, to the AMF 904 an N2 PDU session

resource setup response.

At 935-936, the AMF 904 may transmit an Nsmf_PDUSession_UpdateSMContext request to the SMF 905, including the SM context ID, the N2 SM information, and/or request type etc.

At 937-938, the SMF 905 may initiate the N4 session modification procedure with the UPF, provide the AN tunnel information and transmit the rules. If redundant transmission is needed for the one or more QoS flows, the SMF 905 may instruct the UPF to perform packet duplication in the downlink direction. In cases involving two I-UPFs for redundancy, the SMF 905 may provide the AN tunnel information to both I-UPFs and configure the PSA UPF for packet duplication, while exchanging tunnel information between them. If the PDU Set based handling support indication is included, the SMF 905 may configure the PSA UPF for PDU Set marking. After the UPF responds with an N4 session modification response, any buffered downlink packets may be transmitted to the RG 901 (e.g., FN-RG).

At 939-940, if the request type is neither the emergency request nor the existing emergency PDU session and the SMF 905 has not yet registered the PDU session, the SMF 905 may register with the UDM using Nudm_UECM_Registration, providing the key session information (e.g., the SUPI, the DNN, the S-NSSAI, the PDU Session ID, and/or the SMF identity, etc.). The UDM may store the information in the UDR. If the event exposure subscriptions are applicable for the RG 901 (e.g., FN-RG), the UDM may initiate the Nsmf_EventExposure_Subscribe service. For the emergency requests, the SMF 905 may register with the UDM for authenticated non-roaming UEs, while for unauthenticated or roaming UEs, registration may not be performed.

At 941-942, the SMF 905 may respond to the AMF 904 with the cause for the PDU session context update. The SMF 905 may also subscribe to the RG (e.g., 5G-RG and/or FN-RG) mobility events using the Namf_EventExposure_Subscribe service. If the PDU session establishment fails at any point, the SMF 905 may inform the AMF 904, release N4 sessions, any allocated PDU session addresses, and end the PCF association if applicable. For non-roaming subscribers, if no other PDU session uses the same S-NSSAI, the AMF 904 may start the slice deregistration inactivity timer.

At 943, for the PDU session types IPV6 and/or IPv4v6, the SMF 905 may generate the IPV6 router advertisement for the RG (e.g., 5G-RG and/or FN-RG).

At 944, when the trigger for 5GS bridge and/or router information becomes available, the SMF 905 may initiate the SM policy association modification.

At 945, If the PDU session establishment fails, the SMF 905 may unsubscribe from the session management subscription data, and the UDM may also unsubscribe from the modification notifications.

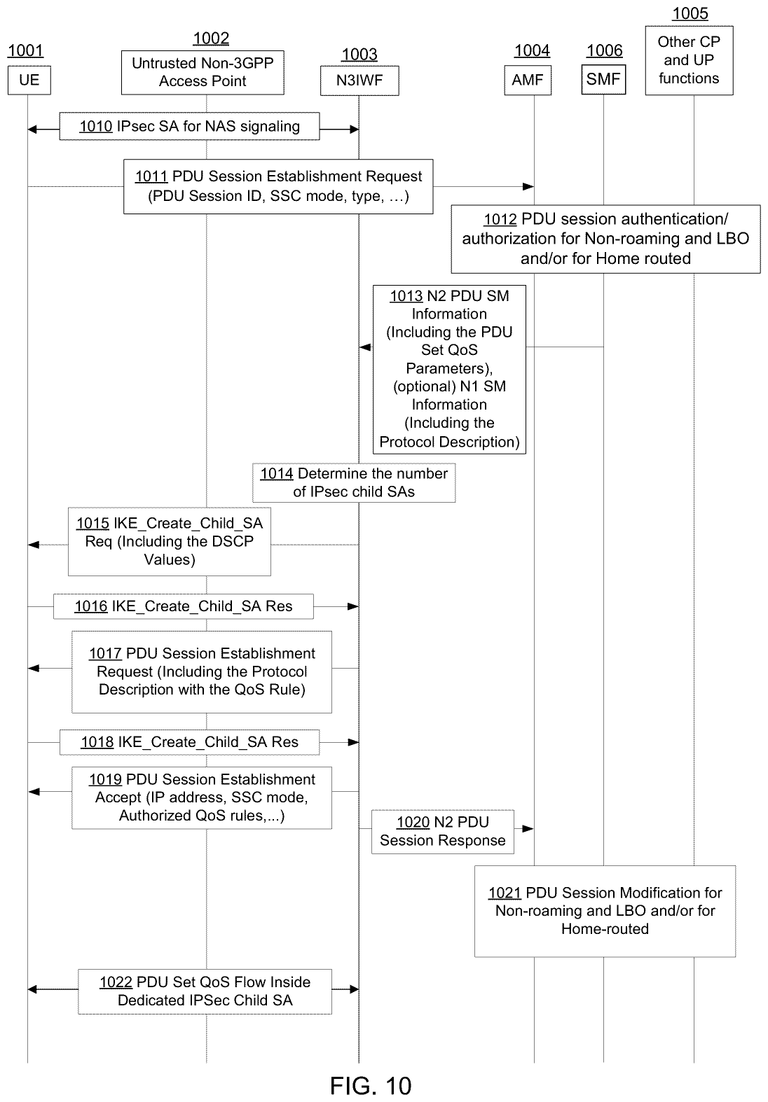

FIG. 10 illustrates a procedure for an example untrusted non-3GPP access, according to one or more embodiments. The procedure may be performed between a UE 1001, an untrusted non-3GPP access point 1002, a N3IWF 1003, an AMF 1004, one or more UP and/or CP functions 1005, and a SMF 1006.

At 1010-1011, the UE 1001 may transmit a PDU session establishment request message to the AMF 1004. The PDU session establishment request message may be transmitted to the N3IWF 1003 via an IPsec SA for NAS signaling and the N3IWF 1003 may transparently forward the PDU session establishment request message to the AMF 1004 in the 5GC.

At 1012, in a case of non-roaming or roaming with local breakout, and/or in the case of home-routed roaming, one or more PDU session establishment procedures with PDU session authentication/authorization may be performed.

At 1013, the N2 SM information carries information that the AMF 1004 may forward to the N3IWF 1003. The N2 SM information includes but is not limited to: at least one PDU Set QoS parameter to activate PDU Set QoS handling for a given QoS flow. The N1 SM container that the AMF 1004 may provide to the UE 1001 may include, for each QoS flow for which UL PDU Set based QoS handling needs to be enabled, a protocol description for identifying the PDU Set. The AMF 1004 may, under request of the SMF 1006 send a N2 PDU session resource setup request message, which includes the one or more PDU Set QoS parameters, to the N3IWF 1003 to establish the non-3GPP access resources for this PDU session.

At 1014, for PDU Set-enabled QoS flow, the N3IWF 1003 establishes a dedicated IPsec Child SA.

At 1015, the N3IWF 1003 may transmit to the UE 1001 an internet key exchange (IKE) Create_Child_SA request which may include a DSCP value associated with the Child SA, based on operator policy.

At 1016, if the UE 1001 accepts the new IPsec Child SA, the UE 1001 may transmit an IKE Create_Child_SA response.

At 1017, after the IPsec Child SA is established, the N3IWF 1003 shall forward to UE 1001 via the signaling IPsec SA the PDU session establishment accept message (including the protocol description associated with the QoS Rule).

At 1018, if the UE 1001 accepts the new IPsec Child SA, the UE 1001 shall transmit an IKE Create_Child_SA response.

At 1019, after all IPsec Child SAs are established, the N3IWF 1003 may forward to UE 1001 via the signaling IPsec SA, the PDU Session establishment accept message.

At 1020, the N3IWF 1003 may transmit, to the AMF 1004 an N2 PDU session response.

At 1021, in the case of non-roaming or roaming with local breakout, and/or in the case of home-routed roaming, one or more processes for PDU session modification may be performed according to the PDU session establishment procedure over 3GPP access.

At 1022, the one or more PDUs belonging to the one or more PDU Set-enabled QoS flows may be transferred over the corresponding dedicated IPsec Child SA.

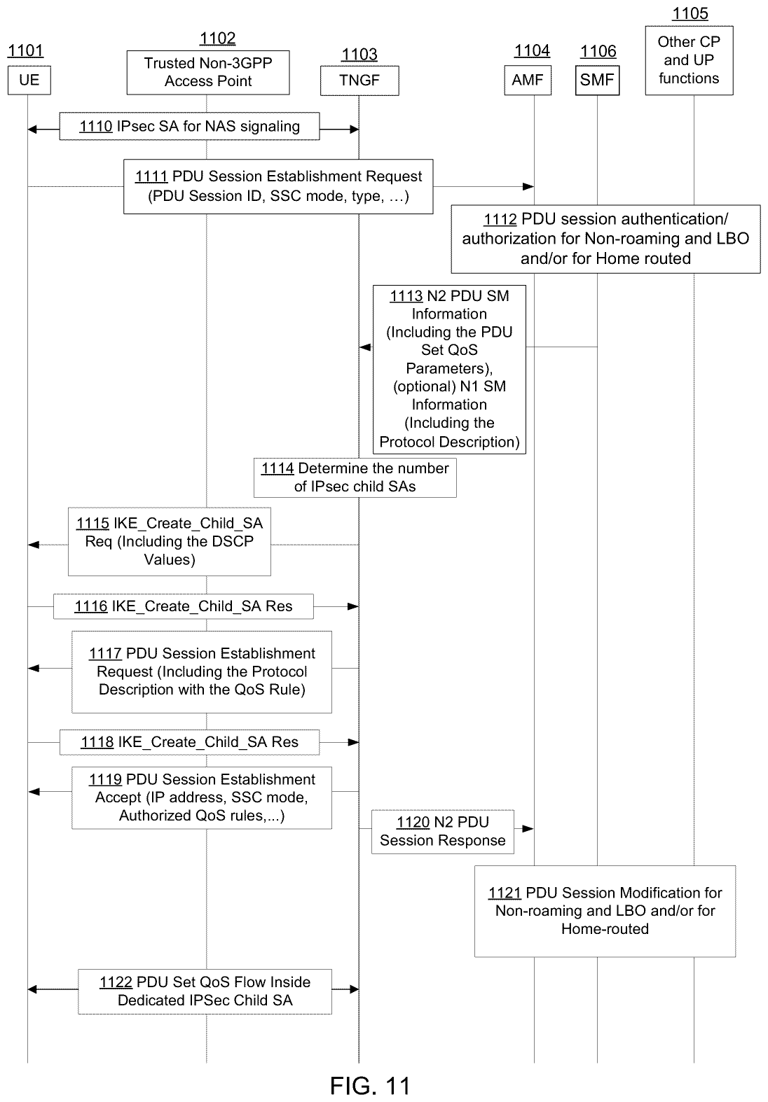

FIG. 11 illustrates a procedure for an example trusted non-3GPP access, according to one or more embodiments. The procedure may be performed between a UE 1101, a trusted non-3GPP access point (TNAP) 1102, a trusted non-3GPP gateway function (TNGF) 1103, an AMF 1104, one or more UP and/or CP functions 1105, and a SMF 1106.

At 1110-1111, the UE 1101 may transmit a PDU session establishment request message to the AMF 1104. The PDU session establishment request message may be transmitted to the TNGF 1103 via an IPsec SA for NAS signaling and the TNGF 1103 may transparently forward the PDU session establishment request message to the AMF 1104 in the 5GC.

At 1112, in a case of non-roaming or roaming with local breakout, and/or in the case of home-routed roaming, one or more PDU session establishment procedures with PDU session authentication/authorization may be performed.

At 1113, the N2 SM information carries information that the AMF 1104 may forward to the TNGF 1103. The N2 SM information includes but is not limited to: at least one PDU Set QoS parameter to activate PDU Set QoS handling for a given QoS flow. The N1 SM container that the AMF 1104 may provide to the UE 1101 may include, for each QoS flow for which UL PDU Set based QoS handling needs to be enabled, a protocol description for identifying the PDU Set. The AMF 1104 may, under request of the SMF 1106 send a N2 PDU session resource setup request message, which includes the one or more PDU Set QoS parameters, to the TNGF 1103 to establish the non-3GPP access resources for this PDU session.

At 1114, for PDU Set-enabled QoS Flow, the TNGF 1103 establishes a dedicated IPsec Child SA.

At 1115, the TNGF 1103 may transmit to the UE 1101 an IKE Create_Child_SA request which may include a DSCP value associated with the Child SA, based on operator policy.

At 1116, if the UE 1101 accepts the new IPsec Child SA, the UE 1101 may transmit an IKE Create_Child_SA response.

At 1117, after the IPsec Child SA is established, the TNGF 1103 may forward to UE 1101 via the signaling IPsec SA the PDU session establishment accept message (including the protocol description associated with the QoS Rule).

At 1118, if the UE 1101 accepts the new IPsec Child SA, the UE 1101 shall transmit an IKE Create_Child_SA response.

At 1119, after all IPsec Child SAs are established, the TNGF 1103 may forward to UE 1101 via the signaling IPsec SA, the PDU Session establishment accept message.

At 1120, the TNGF 1103 may transmit, to the AMF 1104 an N2 PDU session response.

At 1121, in the case of non-roaming or roaming with local breakout, and/or in the case of home-routed roaming, one or more processes for PDU session modification may be performed according to the PDU session establishment procedure over 3GPP access.

At 1122, the one or more PDUs belonging to the one or more PDU Set-enabled QoS flows may be transferred over the corresponding dedicated IPsec Child SA.

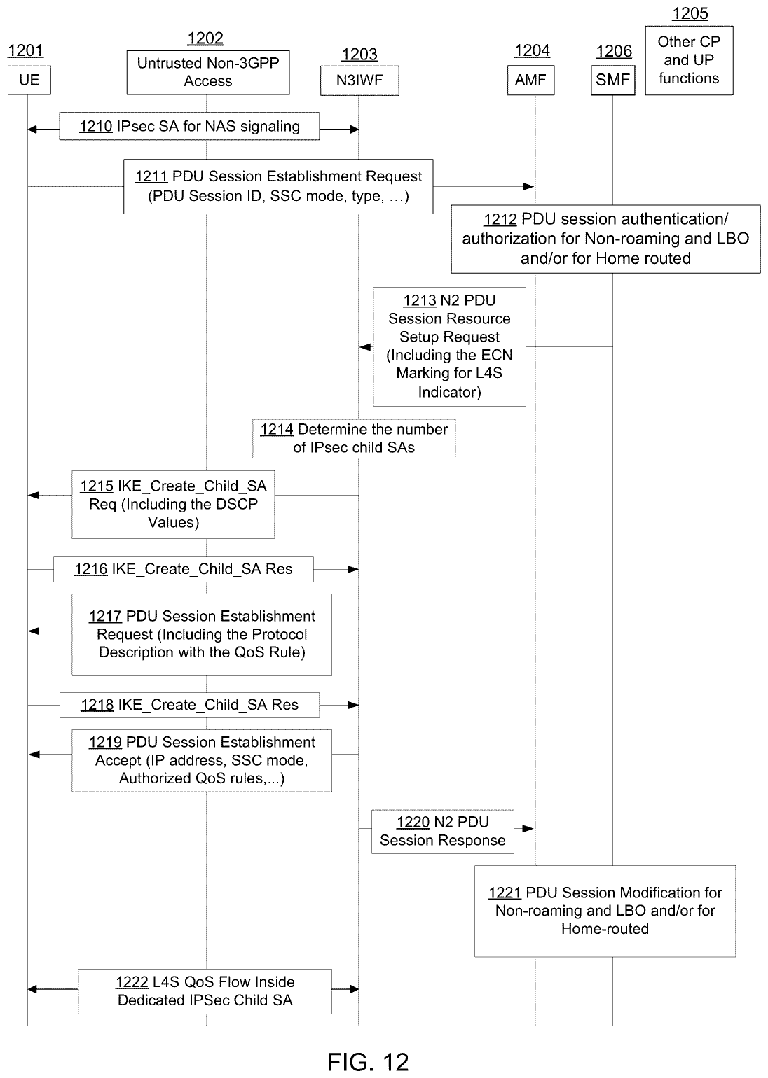

FIG. 12 illustrates a procedure for an example untrusted non-3GPP access, according to one or more embodiments. The procedure may be performed between a UE 1201, an untrusted non-3GPP access point 1202, a N3IWF 1203, an AMF 1204, one or more UP and/or CP functions 1205, and a SMF 1206.

At 1210-1211, the UE 1201 may transmit a PDU session establishment request message to the AMF 1204. The PDU session establishment request message may be transmitted to the N3IWF 1203 via an IPsec SA for NAS signaling and the N3IWF 1203 may transparently forward the PDU session establishment request message to the AMF 1204 in the 5GC.

At 1212, in a case of non-roaming or roaming with local breakout, and/or in the case of home-routed roaming, one or more PDU session establishment procedures with PDU session authentication/authorization may be performed.

At 1213, the N2 SM information carries information that the AMF 1204 may forward to the N3IWF 1203 which includes but is not limited to: for each QoS flow, an ECN marking for L4S indicator in the case of ECN marking for L4S in untrusted non-3GPP access. The N1 SM container that the AMF 1204 may provide to the UE 1201 may include, for each QoS flow for which UL PDU Set based QoS handling needs to be enabled, a protocol description for identifying the PDU Set. The AMF 1204 may under request of the SMF 1206 transmit a N2 PDU session resource setup request message, which includes the ECN marking for L4S indicator, to the N3IWF 1203 to establish the non-3GPP access resources for this PDU session.

At 1214, for an L4S-enabled QoS flow, the N3IWF 1203 establishes a dedicated IPsec Child SA.

At 1215, the N3IWF 1203 may transmit to the UE 1201 an IKE Create_Child_SA request which may include a DSCP value associated with the Child SA, based on operator policy.

At 1216, if the UE 1201 accepts the new IPsec Child SA, the UE 1201 may transmit an IKE Create_Child_SA response.

At 1217, after the IPsec Child SA is established, the N3IWF 1203 shall forward to UE 1201 via the signaling IPsec SA the PDU session establishment accept message (including the protocol description associated with the QoS Rule).

At 1218, if the UE 1201 accepts the new IPsec Child SA, the UE 1201 shall transmit an IKE Create_Child_SA response.

At 1219, after all IPsec Child SAs are established, the N3IWF 1203 may forward to UE 1201 via the signaling IPsec SA, the PDU Session establishment accept message.

At 1220, the N3IWF 1203 may transmit, to the AMF 1204 an N2 PDU session response.

At 1221, in the case of non-roaming or roaming with local breakout, and/or in the case of home-routed roaming, one or more processes for PDU session modification may be performed according to the PDU session establishment procedure over 3GPP access.

At 1222, the one or more PDUs belonging to the one or more L4S-enabled QoS flows may be transferred over the corresponding dedicated IPsec Child SA.

On the user-plane, the one or more PDUs belonging to L4S-enabled QoS flow are transferred over dedicated IPsec child SA. If a DSCP value is included, then the UE 1201 and the N3IWF 1203 may mark all IP packets sent over this Child SA with this DSCP value.

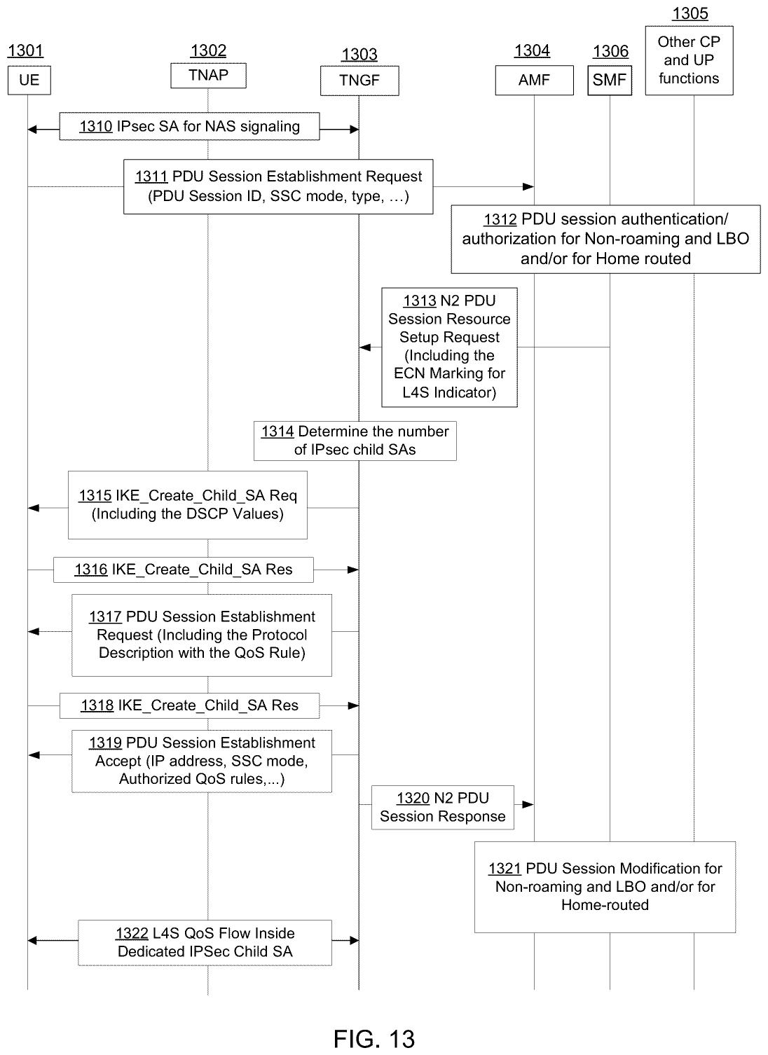

FIG. 13 illustrates a procedure for an example trusted non-3GPP access, according to one or more embodiments. The procedure may be performed between a UE 1301, a TNAP 1302, a TNGF 1303, an AMF 1304, one or more UP and/or CP functions 1305, and SMF 1306.

At 1310-1311, the UE 1301 may transmit a PDU session establishment request message to the AMF 1304. The PDU session establishment request message may be transmitted to the TNGF 1303 via an IPsec SA for NAS signaling and the TNGF 1303 may transparently forward the PDU session establishment request message to the AMF 1304 in the 5GC.

At 1312, in a case of non-roaming or roaming with local breakout, and/or in the case of home-routed roaming, one or more PDU session establishment procedures with PDU session authentication/authorization may be performed.

At 1313, the N2 SM information carries information that the AMF 1304 may forward to the TNGF 1303 which includes but is not limited to: for each QoS flow, an ECN marking for L4S indicator in the case of ECN marking for L4S in untrusted non-3GPP access. The N1 SM container that the AMF 1304 may provide to the UE 1301 may include, for each QoS flow for which UL PDU Set based QoS handling needs to be enabled, a protocol description for identifying the PDU Set. The AMF 1304 may under request of the SMF 1306 send a N2 PDU session resource setup request message, which includes the ECN marking for L4S indicator, to the TNGF 1303 to establish the non-3GPP access resources for this PDU session.

At 1314, for an LAS-enabled QoS flow, the TNGF 1303 establishes a dedicated IPsec Child SA.

At 1315, the TNGF 1303 may transmit to the UE 1301 an IKE Create_Child_SA request which may include a DSCP value associated with the Child SA, based on operator policy.

At 1316, if the UE 1301 accepts the new IPsec Child SA, the UE 1301 may transmit an IKE Create_Child_SA response.

At 1317, after the IPsec Child SA is established, the N3IWF 1303 shall forward to UE 1301 via the signaling IPsec SA the PDU session establishment accept message (including the protocol description associated with the QoS Rule).

At 1318, if the UE 1301 accepts the new IPsec Child SA, the UE 1301 shall transmit an IKE Create_Child_SA response.

At 1319, after all IPsec Child SAs are established, the N3IWF 1303 may forward to UE 1301 via the signaling IPsec SA, the PDU session establishment accept message.

At 1320, the N3IWF 1303 may transmit, to the AMF 1304 an N2 PDU session response.

At 1321, in the case of non-roaming or roaming with local breakout, and/or in the case of home-routed roaming, one or more processes for PDU session modification may be performed according to the PDU session establishment procedure over 3GPP access.

At 1322, the one or more PDUs belonging to the one or more L4S-enabled QoS flows may be transferred over the corresponding dedicated IPsec Child SA.

On the user-plane, the one or more PDUs belonging to an L4S-enabled QoS flow are transferred over dedicated IPsec child SA. If a DSCP value is included, then the UE 1301 and the TNGF 1303 may mark all IP packets sent over this Child SA with this DSCP value.

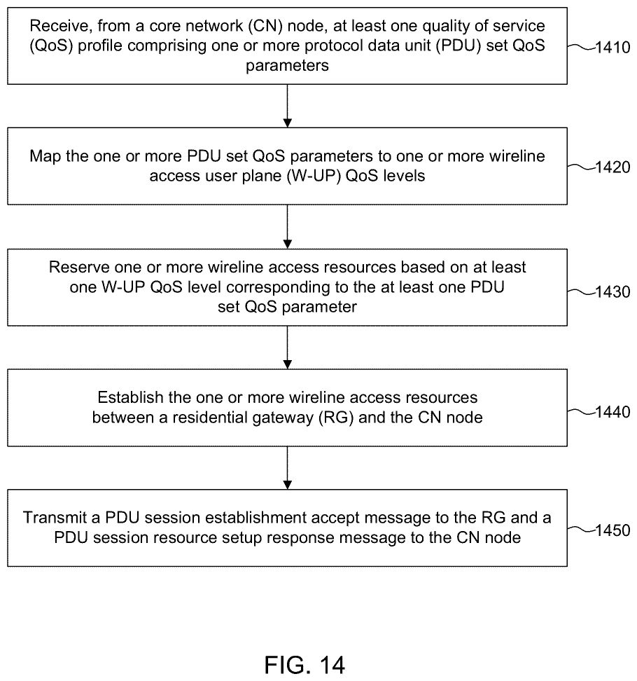

FIG. 14 illustrates a flowchart of an example process implemented by the W-AGF for the PDU Set QoS handling enabled wireline access, according to one or more embodiments. At 1410, the W-AGF receives the QoS profiles from the CN node. The QoS profiles comprise the PDU Set QoS parameters. For the QoS flow with the PDU Set based QoS handling enabled, the PDU Set QoS parameters may be determined by the PCF and provided by the SMF to the W-AGF as a part of the QoS profiles. Examples of the PDU Set QoS parameters used to support the PDU Set based QoS handling in the W-5GAN include but are not limited to PSDB, PSER, and/or PSIHI etc.

At 1420, the W-AGF maps the PDU Set QoS parameters to the W-UP QoS levels. In an example, the W-AGF may map the PDU Set-enabled QoS profile to the corresponding W-UP resource.

At 1430, the W-AGF reserves the wireline access resources based on the W-UP QoS level corresponding to the PDU Set QoS parameter.

At 1440, the W-AGF establishes the wireline access resources between the RG (e.g., 5G-RG) and the CN node.

At 1450, the W-AGF transmits the PDU session establishment accept message to the RG (e.g., 5G-RG) and the PDU session resource setup response message to the CN node. The PDU session establishment accept message includes the protocol description associated with the QoS rules.

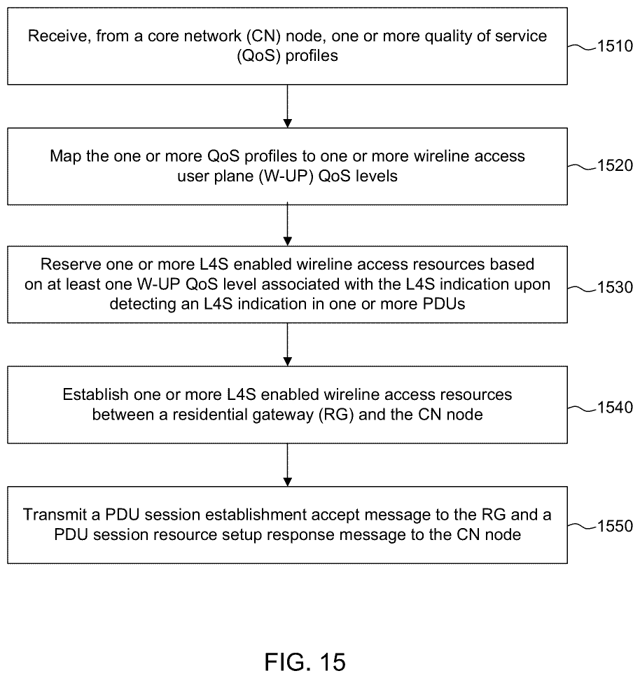

FIG. 15 illustrates a flowchart of an example process implemented by the W-AGF for L4S enabled wireline access, according to one or more embodiments. At 1510, the W-AGF receives the QoS profiles from the CN node.

At 1520, the W-AGF maps the QoS profiles to the W-UP QoS levels. In an example, the W-AGF may perform the mapping of the L4S-enabled QoS profile to the L4S-enabled W-UP resource.

At 1530, upon detecting the L4S indication in the one or more PDUs, the W-AGF reserves the L4S enabled wireline access resources based on the W-UP QoS level associated with the L4S indication.

At 1540, the W-AGF establishes the L4S enabled wireline access resources between the RG (e.g., 5G-RG) and the CN node.

At 1550, the W-AGF transmits the PDU session establishment accept message to the RG (e.g., 5G-RG) and the PDU session resource setup response message to the CN node. The PDU session establishment accept message includes the ECN marking for the L4S indicator.

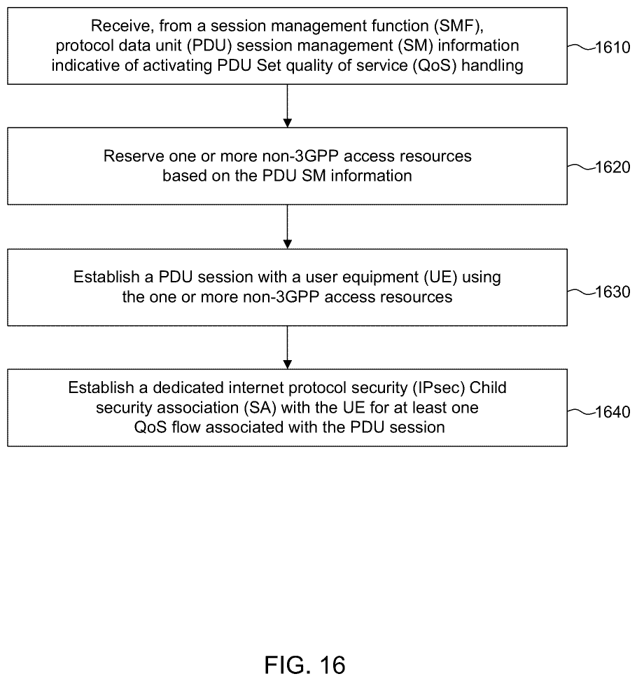

FIG. 16 illustrates a flowchart of an example process implemented by a gateway function for a PDU set QoS handling enabled wireline access, according to one or more embodiments.

At 1610, the gateway receives, from the SMF via the AMF, PDU SM information indicative of activating PDU Set QoS handling.

At 1620, the gateway reserves one or more non-3GPP access resources based on the PDU SM information.

At 1630, the gateway establishes a PDU session with a UE using the one or more non-3GPP access resources.

At 1640, the gateway establishes a dedicated IPsec Child SA with the UE for at least one QoS flow associated with the PDU session.

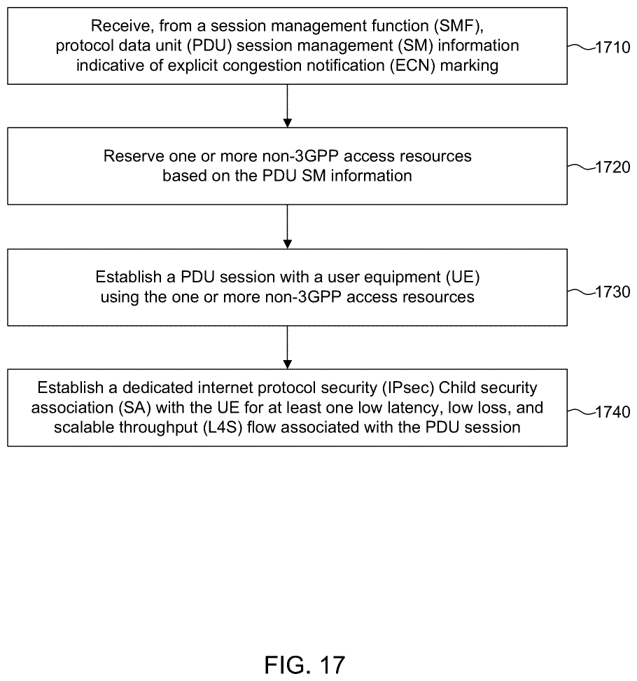

FIG. 17 illustrates a flowchart of an example process implemented by a gateway for an L4S enabled wireline access, according to one or more embodiments.

At 1710, the gateway receives, from the SMF via the AMF, PDU SM information indicative of ECN marking.

At 1720, the gateway reserves one or more non-3GPP access resources based on the PDU SM information.

At 1730, the gateway establishes a PDU session with a UE using the one or more non-3GPP access resources.

At 1740, the gateway establishes a dedicated IPsec Child SA with the UE for at least one L4S flow associated with the PDU session.

What is claimed is:

1. A method performed by a gateway function, the method comprising:
receiving, from a session management function (SMF), protocol data unit (PDU) session management (SM) information indicative of activating PDU Set quality of service (QoS) handling;
reserving one or more non-3GPP access resources based on the PDU SM information;
establishing a PDU session with a user equipment (UE) using the one or more non-3GPP access resources; and
establishing a dedicated internet protocol security (IPsec) Child security association (SA) with the UE for at least one QoS flow associated with the PDU session.

2. The method of claim 1, the method further comprising:
exchanging one or more PDUs associated with the at least one QoS flow with the UE using the dedicated IPsec Child SA.

3. The method of claim 1, wherein the PDU SM information comprises a protocol description.

4. The method of claim 3, the method further comprising:
identifying, based on the protocol description, a PDU Set associated with the PDU session for which PDU Set QoS handling is activated.

5. The method of claim 1, wherein the PDU SM information comprises one or more QoS parameters.

6. The method of claim 5, the method further comprising:
determining, based on the one or more QoS parameters, one or more differentiated service code point (DSCP) values associated with the dedicated IPsec Child SA.

7. The method of claim 6, wherein establishing the dedicated IPsec Child SA comprises:
transmitting, to the UE, a request to create the dedicated IPsec Child SA, wherein the request to create the dedicated IPsec Child SA comprises the one or more DSCP values.

8. The method of claim 1, wherein the gateway function is a non-3GPP interworking function (N3IWF) in communication with an untrusted non-3GPP access network.

9. The method for claim 1, wherein the gateway function is a trusted non-3GPP gateway function (TNGF) in communication with a trusted non-3GPP access network.

10. A device comprising:
a memory;
a transceiver; and
a processor, wherein the transceiver and the processor are configured to:
receive, from a session management function (SMF), protocol data unit (PDU) session management (SM) information indicative of activating PDU Set quality of service (QoS) handling,
reserve one or more non-3GPP access resources based on the PDU SM information,
establish a PDU session with a user equipment (UE) using the one or more non-3GPP access resources, and
establish a dedicated internet protocol security (IPsec) Child security association (SA) with the UE for at least one QoS flow associated with the PDU session.

11. The device of claim 10, wherein the transceiver and the processor are further configured to:
exchange one or more PDUs associated with the at least one QoS flow with the UE using the dedicated IPsec Child SA.

12. The device of claim 10, wherein the PDU SM information comprises a protocol description.

13. The device of claim 12, wherein the transceiver and the processor are further configured to:
identify, based on the protocol description, a PDU Set associated with the PDU session for which PDU Set QoS handling is activated.

14. The device of claim 10, wherein the PDU SM information comprises one or more QoS parameters.

15. The device of claim 14, wherein the transceiver and the processor are further configured to:
determine, based on the one or more QoS parameters, one or more differentiated service code point (DSCP) values associated with the dedicated IPsec Child SA.

16. The device of claim 15, wherein establishing the dedicated IPsec Child SA comprises:
transmitting, to the UE, a request to create the dedicated IPsec Child SA, wherein the request to create the dedicated IPsec Child SA comprises the one or more DSCP values.

17. The device of claim 10, wherein the device is a non-3GPP interworking function (N3IWF) in communication with an untrusted non-3GPP access network.

18. The device for claim 10, wherein the device is a trusted non-3GPP gateway function (TNGF) in communication with a trusted non-3GPP access network.

19. A method performed by a gateway function, the method comprising:
receiving, from a session management function (SMF), protocol data unit (PDU) session management (SM) information indicative of explicit congestion notification (ECN) marking;
reserving one or more non-3GPP access resources based on the PDU SM information;
establishing a PDU session with a user equipment (UE) using the one or more non-3GPP access resources; and
establishing a dedicated internet protocol security (IPsec) Child security association (SA) with the UE for at least one low latency, low loss, and scalable throughput (L4S) flow associated with the PDU session.

20. The method of claim 19, the method further comprising:
exchanging one or more PDUs associated with the at least one L4S flow with the UE using the dedicated IPsec Child SA.

21. The method of claim 19, wherein the PDU SM information comprises a protocol description.

22. The method of claim 21, the method further comprising:
identifying, based on the protocol description, a PDU Set associated with the PDU session for which ECN marking is activated.

23. The method of claim 19, wherein the PDU SM information comprises one or more QoS parameters.

24. The method of claim 23, the method further comprising:
determining, based on the one or more QoS parameters, one or more differentiated service code point (DSCP) values associated with the dedicated IPsec Child SA.

25. The method of claim 24, wherein establishing the dedicated IPsec Child SA comprises:
transmitting, to the UE, a request to create the dedicated IPsec Child SA, wherein the request to create the dedicated IPsec Child SA comprises the one or more DSCP values.

26. The method of claim 19, wherein the gateway function is a non-3GPP interworking function (N3IWF) in communication with an untrusted non-3GPP access network.

27. The method for claim 19, wherein the gateway function is a trusted non-3GPP gateway function (TNGF) in communication with a trusted non-3GPP access network.

28. A device comprising:
a memory;
a transceiver; and
a processor, wherein the transceiver and the processor are configured to:
receive, from a session management function (SMF), protocol data unit (PDU) session management (SM) information indicative of explicit congestion notification (ECN) marking,
reserve one or more non-3GPP access resources based on the PDU SM information,
establish a PDU session with a user equipment (UE) using the one or more non-3GPP access resources, and
establish a dedicated internet protocol security (IPsec) Child security association (SA) with the UE for at least one low latency, low loss, and scalable throughput (L4S) flow associated with the PDU session.

29. The device of claim 28, wherein the transceiver and the processor are further configured to:
exchange one or more PDUs associated with the at least one L4S flow with the UE using the dedicated IPsec Child SA.

30. The device of claim 28, wherein the PDU SM information comprises a protocol description.

31. The device of claim 30, wherein the transceiver and the processor are further configured to:
identify, based on the protocol description, a PDU Set associated with the PDU session for which ECN marking is activated.

32. The device of claim 28, wherein the PDU SM information comprises one or more QoS parameters.

33. The device of claim 32, wherein the transceiver and the processor are further configured to:
determine, based on the one or more QoS parameters, one or more differentiated service code point (DSCP) values associated with the dedicated IPsec Child SA.

34. The device of claim 33, wherein establishing the dedicated IPsec Child SA comprises:
transmitting, to the UE, a request to create the dedicated IPsec Child SA, wherein the request to create the dedicated IPsec Child SA comprises the one or more DSCP values.

35. The device of claim 28, wherein the device is a non-3GPP interworking function (N3IWF) in communication with an untrusted non-3GPP access network.

36. The device for claim 28, wherein the device is a trusted non-3GPP gateway function (TNGF) in communication with a trusted non-3GPP access network.
